(19) United States
(12) Patent Application Publication
(10) Pub. No.: US 2013/0340809 A1
(43) Pub. Date: Dec. 26, 2013

(54) DYE-SENSITIZED PHOTOVOLTAIC DEVICE AND FABRICATION METHOD FOR THE SAME

(71) Applicant: ROHM CO., LTD., Kyoto (JP)

(72) Inventor: Yoichi AOKI, Kyoto (JP)

(73) Assignee: ROHM CO., LTD., Kyoto (JP)

(21) Appl. No.: 13/914,580

(22) Filed: Jun. 10, 2013

(30) Foreign Application Priority Data
Jun. 11, 2012 (JP) 2012-132142
May 9, 2013 (JP) 2013-099324

(51) Int. Cl. H01G 9/20

(52) U.S. Cl. CPC H01G 9/2077
USPC 136/249; 136/259; 136/251; 438/64

(57) ABSTRACT

Provided are a dye-sensitized photovoltaic device which can reduce fabrication costs and improve durability, and a fabrication method of such a dye-sensitized photovoltaic device. The dye-sensitized photovoltaic device includes: a first substrate 20; a first electrode 10 disposed on the first substrate; a porous semiconductor layer 12 disposed on the first electrode and including semiconductor fine particles and dye molecules; an electrolysis solution 14 contacted with the porous semiconductor layer and dissolving a redox electrolyte in a solvent; a second electrode 18 contacted with the electrolysis solution; a second substrate 22 disposed on the second electrode; and a sealed part for sealing the electrolysis solution, the sealed part 36 disposed between the second substrate and the first substrate, wherein the sealed part is configured to which a burning body of a paste containing a glass frit is fusion bonded.

### CROSS REFERENCE TO RELATED APPLICATIONS AND INCORPORATION BY REFERENCE

This application is based upon and claims the benefit of priority from prior Japanese Patent Application Nos. P2012-132142 filed on Jun. 11, 2012, and P2013-099324 filed on May 9, 2013, the entire contents of which are incorporated herein by reference.

### TECHNICAL FIELD

The present invention relates to dye-sensitized photovoltaic devices (Dye-sensitized Solar Cells (DSCs)) and a fabrication method for the same. In particular, the present invention relates to DSCs which can reduce fabrication costs and can improve durability, and to a fabrication method of such DSCs.

### BACKGROUND ART

In recent years, DSCs have received attention as inexpensive and high-performance solar cells. The DSCs were developed by Graetzel at Ecole Polytechnique Federale de Lausanne in Switzerland. A titanium oxide which supports sensitizing dyes on the surface thereof is used for the DSCs. Accordingly, since the DSCs have advantages, such as high in photoelectric conversion efficiency and a low manufacturing cost, it is expected as next-generation solar cells. Since such solar cells encapsulate an electrolysis solution with the inside, it is also designated as wet solar cells.

The DSCs have a structure in which a titanium oxide having tens of μm thicknesses to which dyes (e.g. a red die (N719), a black die (N749), etc.) are adsorbed and an electrolysis solution in which an electrolyte (e.g. an iodine) is added to an organic solvent (e.g. an acetonitrile) are inserted between a glass substrate in which a transparent electrode (e.g. ITO, FTO, etc.) are formed and a substrate which Pt is laminated on a glass substrate in which a transparent electrode (e.g. ITO, FTO, etc.) are formed.

Moreover, in order to keep hold and protect of the titanium oxide, to which dyes are adsorbed, and the electrolysis solution, edges of the opposed two substrates is covered and sealed with a resin (for example, refer to Patent Literature 1.).

DSCs having monolithic structure are disclosed in Patent Literatures 2-4. According to such monolithic structure, it is not necessary to have a counter-electrode substrate, thereby reducing costs correspondingly. Moreover, since it can be fabricated by laminating each layer one after another on a substrate (single plate) composing a working electrode, there are advantages that fabricating process is comparatively easy, and it is suitable for mass fabrication.

### CITATION LIST

Patent Literature 1: Japanese Patent Application Laying-Open Publication No. 2010-277722
Patent Literature 2: Japanese Patent Application Laying-Open Publication No. 2009-110796
Patent Literature 3: Japanese Patent Application Laying-Open Publication No. 2006-236960
Patent Literature 4: International publication No. 2008/149811

### SUMMARY OF THE INVENTION

### Technical Problem

In conventionally, although a photo-curing resin (e.g. ultraviolet curing resin) was used as a resin for sealing the substrate, since a moisture and an oxygen comparatively easily infiltrated into an inside of the cells, sufficient durability was not able to be secured.

That is, since such a UV curing resin is lacking in temperature resistance and moisture resistance, there was a problem that the resin is easily separated therefrom under a hot and humid environment.

Moreover, there was also a problem that power generation characteristics are reduced since a part of resin components is eluted to the electrolysis solution.

Moreover, there was also a problem that a process number increased in the case of sealing the substrate using such a UV curing resin etc., thereby increasing fabrication costs.

The present invention is achieved to solve the problems mentioned above, and the object of the present invention is to provide a dye-sensitized photovoltaic device which can fully cure a sealed part, thereby improving durability, and provide a fabrication method of such a dye-sensitized photovoltaic device.

### Solution to Problem

According to one aspect of the present invention for achieving the above-mentioned object, there is provided a dye-sensitized photovoltaic device comprising: a first substrate; a first electrode disposed on the first substrate; a porous semiconductor layer disposed on the first electrode and configured to include semiconductor fine particles and dye molecules; an electrolysis solution configured to be contacted with the porous semiconductor layer, and to dissolve a redox electrolyte in a solvent; a second electrode configured to be contacted with the electrolysis solution; a second substrate disposed on the second electrode; and a sealed part disposed between the first substrate and the second substrate, and configured to seal the electrolysis solution, wherein the sealed part is configured to which a burning body of a paste containing a glass frit is fusion bonded.

According to another aspect of the present invention, there is provided a fabrication method of a dye-sensitized photovoltaic device, the fabrication method comprising: forming a first electrode on a first substrate; forming a porous semiconductor layer having semiconductor fine particles on the first electrode; impregnating the porous semiconductor layer with a dye solution to adsorbing dye molecules; forming the second electrode on the second substrate; coating a paste containing a glass frit on the first substrate side and forming a first base part having a predetermined height; coating the paste containing the glass frit on the second substrate side and forming a second base part having a predetermined height; annealing the first base part and the second base part; contacting the first base part with the second base part so that the first substrate and the second substrate are opposed to each other; irradiating a contact part between the first base part and the second base part with infrared laser to be fusion bonded to each other; and injecting an electrolysis solution in which a redox electrolyte is dissolved in a solvent between the first substrate and the second substrate.

According to still another aspect of the present invention, there is provided a fabrication method of a dye-sensitized photovoltaic device, the fabrication method comprising: forming a first electrode on a first substrate; forming a porous semiconductor layer having semiconductor fine particles on the first electrode; impregnating the porous semiconductor layer with a dye solution to adsorbing dye molecules; forming the second electrode on the second substrate; coating a paste containing glass frit on any one of the first substrate side and the second substrate side, and forming a first base part or a second base part having a predetermined height; annealing the first base part or the second base part; contacting the first base part with the second base part, or the second base part with the first substrate so that the first substrate and the second substrate are opposed to each other; irradiating a contact part between the first base part and the second substrate, or a contact part between the second base part and the first substrate with infrared laser to be fusion bonded to each other; and injecting an electrolysis solution in which a redox electrolyte is dissolved in a solvent between the first substrate and the second substrate.

According to still another aspect of the present invention, there is provided a fabrication method of a dye-sensitized photovoltaic device, the fabrication method comprising: forming a first substrate; forming a second substrate; forming a second electrode on the first substrate; forming a separator having a predetermined height on the second electrode; forming a porous semiconductor layer having semiconductor particulates on the separator; impregnating the porous semiconductor layer with a dye solution to adsorbing dye molecules; forming a first electrode being a metal electrode having an aperture on the porous semiconductor layer; and sealing an electrolysis solution in which a redox electrolyte is dissolved in a solvent with a sealed part disposed between the first substrate and the second substrate.

### Advantageous Effects of Invention

According to the present invention, there can be provided a dye-sensitized photovoltaic device which can reduce fabrication costs and improve durability, and a fabrication method of such a dye-sensitized photovoltaic device.

### BRIEF DESCRIPTION OF DRAWINGS

FIG. 1 is a schematic cross-sectional structure diagram showing DSCs according to a first embodiment.

FIG. 2 is a schematic configuration diagram showing semiconductor fine particles of a porous semiconductor layer shown in FIG. 1.

FIG. 3 is an operational principle explanatory diagram of the DSCs according to the first embodiment.

FIG. 4 is an explanatory diagram of an operational principle based on a charge exchange reaction in an electrolysis solution of the DSCs according to the first embodiment.

FIG. 5 is an energy potential diagram between a porous semiconductor layer (12)/dye molecules (32)/an electrolysis solution (14) in the DSCs according to the first embodiment.

FIG. 6 is an energy potential diagram between the dye molecules (32)/the electrolysis solution (14) in the DSCs according to the first embodiment, and is an enlarged drawing showing a portion J shown in FIG. 5.

FIG. 7 is an explanatory diagram showing an energy level of each component and a power generation cycle, in the DSCs according to the first embodiment.

FIG. 8A shows a chemical structural formula showing a dye used for the DSCs according to the first embodiment, and shows a chemical structural formula showing an indoline based dye (D149).

FIG. 8B shows a chemical structural formula showing a dye used for the DSCs according to the first embodiment, and shows a chemical structural formula showing N719.

FIG. 8C shows a chemical structural formula showing a dye used for the DSCs according to the first embodiment, and shows a chemical structural formula showing D131.

FIG. 9 is a diagram showing a process of forming a sealed part, and is a cross-sectional diagram showing the state of forming a second electrode and a catalyst layer on a second substrate.

FIG. 10 is a diagram showing a process of forming the sealed part, and is a cross-sectional diagram showing the state of forming a second base part on the catalyst layer shown in FIG. 9.

FIG. 11 is a diagram showing a process of forming the sealed part, and is a cross-sectional diagram showing the state of forming a first electrode and a porous semiconductor layer on a first substrate.

FIG. 12 is a diagram showing a process of forming the sealed part, and is a cross-sectional diagram showing the state of forming a first base part on the first electrode shown in FIG. 11.

FIG. 13 is a diagram showing a process of forming the sealed part, and is a cross-sectional diagram showing the state of adsorbing a dye to the porous semiconductor layer shown in FIG. 12.

FIG. 14 is a diagram showing a process of forming the sealed part, and is a cross-sectional diagram showing the state where an electrolysis solution is dropped on the first substrate side shown in FIG. 13, and the second substrate shown in FIG. 10 is opposed to the first substrate in the state where the second base part points downward.

FIG. 15 is a diagram showing a process of forming the sealed part, and is a cross-sectional diagram showing the state of irradiating the contact part thereof with infrared laser, in the state of contacting the first base part and the second base part so as to be opposed to each other from the state shown in FIG. 14.

FIG. 16 is a diagram showing a process of forming the sealed part, and is a cross-sectional diagram showing the state where the first base part and the second base part are fusion bonded.

FIG. 17 is a diagram showing a process of forming the sealed part, and is a cross-sectional diagram showing the state of forming a second base part only in the second substrate side, and contacting a tip of the second base part to the first substrate on which the electrolysis solution is dropped.

FIG. 18 is a diagram showing a process of forming the sealed part, and is a cross-sectional diagram showing the state of forming the first base part only on the first substrate side, and contacting a tip of the first base part to the second substrate.

FIG. 19A is a diagram showing a variation of the structure of the sealed part, and is a cross-sectional diagram in which showing a structure in which the first base part and the second base part formed in the same height are fusion bonded so as to be opposed to each other.

FIG. 19B is a diagram showing a variation of the structure of the sealed part, and is a cross-sectional diagram in which showing a structure in which the second base part formed in the second substrate side are fusion bonded to the first substrate.

FIG. 19C is a diagram showing a variation of the structure of the sealed part, and is a cross-sectional diagram in which showing a structure in which the first base part formed in the first substrate side are fusion bonded to the second substrate.

FIG. 19D is a diagram showing a variation of the structure of the sealed part, and is a cross-sectional diagram in which showing a structure in which the first base part and the second base part formed in mutually different heights are fusion bonded so as to be opposed to each other.

FIG. 20A is a diagram showing a variation of the structure of the sealed part, and is a cross-sectional diagram showing a structural example of a sealed part according to a first practical example.

FIG. 20B is a diagram showing a variation of the structure of the sealed part, and is a cross-sectional diagram showing a structural example of a sealed part according to a second practical example.

FIG. 20C is a diagram showing a variation of the structure of the sealed part, and is a cross-sectional diagram showing a structural example of a sealed part according to a third practical example.

FIG. 21A is a diagram showing other variation of the structure of the sealed part, and is a cross-sectional diagram showing a structural example of a sealed part according to a fourth practical example.

FIG. 21B is a diagram showing other variation of the structure of the sealed part, and is a cross-sectional diagram showing a structural example of a sealed part according to a fifth practical example.

FIG. 21C is a diagram showing other variation of the structure of the sealed part, and is a cross-sectional diagram showing a structural example of a sealed part according to a sixth practical example.

FIG. 22A is a diagram showing other variation of the structure of the sealed part, and is a cross-sectional diagram showing a structural example of a sealed part according to a seventh practical example.

FIG. 22B is a diagram showing other variation of the structure of the sealed part, and is a cross-sectional diagram showing a structural example of a sealed part according to a eighth practical example.

FIG. 22C is a diagram showing other variation of the structure of the sealed part, and is a cross-sectional diagram showing a structural example of a sealed part according to a ninth practical example.

FIG. 23A is a diagram showing other variation of the structure of the sealed part, and is a cross-sectional diagram showing a structural example of a sealed part according to a tenth practical example.

FIG. 23B is a diagram showing other variation of the structure of the sealed part, and is a cross-sectional diagram showing a structural example of a sealed part according to a eleventh practical example.

FIG. 23C is a diagram showing other variation of the structure of the sealed part, and is a cross-sectional diagram showing a structural example of a sealed part according to a twelfth practical example.

FIG. 24A is a diagram showing other variation of the structure of the sealed part, and is a cross-sectional diagram showing a structural example of a sealed part according to a thirteenth practical example.

FIG. 24B is a diagram showing other variation of the structure of the sealed part, and is a cross-sectional diagram showing a structural example of a sealed part according to a fourteenth practical example.

FIG. 25A is a diagram showing other variation of the structure of the sealed part, and is a cross-sectional diagram showing a structural example of a sealed part according to a fifteenth practical example.

FIG. 25B is a diagram showing other variation of the structure of the sealed part, and is a cross-sectional diagram showing a structural example of a sealed part according to a sixteenth practical example.

FIG. 26A is a diagram showing other variation of the structure of the sealed part, and is a cross-sectional diagram showing a structural example of a sealed part according to a seventeenth practical example.

FIG. 26B is a diagram showing other variation of the structure of the sealed part, and is a cross-sectional diagram showing a structural example of a sealed part according to a eighteenth practical example.

FIG. 27 is a schematic cross-sectional structure diagram of the DSCs according to the first embodiment having serial structure.

FIG. 28 is a cross-sectional diagram showing a structural example of the sealed part.

FIG. 29 is a top view diagram showing a structural example of an air vent part formed in the sealed part.

FIG. 30 is a process chart showing a fabrication method of the DSCs according to the first embodiment, and is a top view diagram and cross-sectional diagram showing a process of forming a transparent electrode on the first substrate.

FIG. 31 is a process chart showing the fabrication method of the DSCs according to the first embodiment, and is a top view diagram and cross-sectional diagram showing a process of forming a forming a porous semiconductor layer.

FIG. 32 is a process chart showing the fabrication method of the DSCs according to the first embodiment, and is a top view diagram and cross-sectional diagram showing the state where a dye is adsorbed to the porous semiconductor layer.

FIG. 33 is a process chart showing the fabrication method of the DSCs according to the first embodiment, and is a top view diagram and cross-sectional diagram showing a process of forming the sealed part.

FIG. 34 is a process chart showing the fabrication method of the DSCs according to the first embodiment, and is a top view diagram and cross-sectional diagram showing a process of bonding between a counter-electrode substrate and a working electrode substrate, and irradiating the sealed part with light to cure the sealed part.

FIG. 35 is a process chart showing the fabrication method of the DSCs according to the first embodiment, and is a top view diagram and cross-sectional diagram showing the state of injecting an electrolysis solution and sealing an injected hole.

FIG. 36 is a top view diagram showing the case where a plurality of the DSCs is formed.

FIG. 37A is a top view diagram showing a structural example of the DSCs.

FIG. 37B is a cross-sectional diagram taken in the line II-II of FIG. 37A.

FIG. 38 is a photographic diagram showing an example of production of the DSCs.

FIG. 39 is a photographic diagram showing another example of production of the DSCs.

FIG. 40 is a schematic cross-sectional structure diagram showing DSCs according to a second embodiment.

FIG. 41 is a schematic cross-sectional structure diagram in which the DSCs shown in FIG. 40 are connected in series.

FIG. 42A is a process chart showing a fabrication method of the DSCs shown in FIG. 41, and is a cross-sectional diagram showing the state where a second base part is formed on a second substrate.

FIG. 42B is a cross-sectional diagram showing the state where a first base part, etc. are formed on a first substrate.

FIG. 42C is a cross-sectional diagram showing the state where a dye is adsorbed to a porous semiconductor layer on the first substrate after the process shown in FIG. 42B.

FIG. 43 is a process chart showing the fabrication method of the DSCs shown in FIG. 41, and is a cross-sectional diagram showing the state where the second base part on the second substrate after the process shown in FIG. 42A and the first base part on the first substrate after the process shown in and FIG. 42C are opposed to each other.

FIG. 44 is a process chart showing the fabrication method of the DSCs shown in FIG. 41, and is a cross-sectional diagram showing the state of irradiating a contact part with infrared laser in the state of contacting the first base part and the second base part after the process shown in FIG. 43.

FIG. 45 is a process chart showing the fabrication method of the DSCs shown in FIG. 41, and is a schematic bird's-eye view showing the state where the first substrate and the second substrate after the process shown in FIG. 44 are immersed in an electrolysis solution.

FIG. 46A is a process chart showing the fabrication method of the DSCs shown in FIG. 41, and is a cross-sectional diagram showing the state of irradiating a contact part with infrared laser in the state of contacting the first base part on the first substrate and the second base part on the second substrate after the process shown in FIG. 45.

FIG. 46B is a process chart showing the fabrication method of the DSCs shown in FIG. 41, and is a cross-sectional diagram showing the state of the contact part after the process shown in FIG. 46A.

FIG. 47A is a schematic planar structure diagram showing an example of a dye-sensitized solar cell module according to the second embodiment.

FIG. 47B is a schematic cross-sectional structure diagram showing an example of the dye-sensitized solar cell module according to the second embodiment.

FIG. 48A is a schematic cross-sectional structure diagram showing DSCs according to a third embodiment.

FIG. 48B is a schematic planar structure diagram showing a first electrode in the DSCs according to the third embodiment.

FIG. 49A shows an example of an optical microscope photograph of the first electrode, in an example of the first electrode shown in FIG. 48.

FIG. 49B shows an example of an optical microscope photograph to which a part of FIG. 49A is expanded, in an example of the first electrode shown in FIG. 48.

FIG. 50 shows an example of an SEM photograph of the first electrode shown in FIG. 48.

FIG. 51A shows a schematic planar structure diagram showing the case where an aperture is square, in a modified example of the first electrode shown in FIG. 48.

FIG. 51B shows a schematic planar structure diagram showing the case where the aperture is circular, in a modified example of the first electrode shown in FIG. 48.

FIG. 52 is a schematic cross-sectional structure diagram in which the DSCs shown in FIG. 48 are connected in series.

FIG. 53A is a process chart showing the fabrication method of the DSCs shown in FIG. 52, and is a cross-sectional diagram showing the state where a second base part is formed on a second substrate.

FIG. 53B is a process chart showing the fabrication method of the DSCs shown in FIG. 52, and is a cross-sectional diagram showing the state where a first base part, etc. are formed on a first substrate.

FIG. 53C is a process chart showing the fabrication method of the DSCs shown in FIG. 52, and is a cross-sectional diagram showing the state where a dye is adsorbed to a porous semiconductor layer on the first substrate after the process shown in FIG. 53B.

FIG. 54 is a process chart showing the fabrication method of the DSCs shown in FIG. 52, and is a cross-sectional diagram showing the state where the second base part on the second substrate after the process shown in FIG. 53A and the first base part on the first substrate after the process shown in and FIG. 53C are opposed to each other.

FIG. 55 is a process chart showing the fabrication method of the DSCs shown in FIG. 52, and is a cross-sectional diagram showing the state of irradiating a contact part with infrared laser in the state of contacting the first base part and the second base part after the process shown in FIG. 54.

FIG. 56 is a cross-sectional diagram showing a structural example of a sealant according to a comparative example.

FIG. 57A is a cross-sectional diagram showing a structural example of a sealant according to a nineteenth practical example.

FIG. 57B is a cross-sectional diagram showing a structural example of a sealant according to a twentieth practical example.

FIG. 57C is a cross-sectional diagram showing a structural example of a sealant according to a twenty-first practical example.

FIG. 57D is a cross-sectional diagram showing a structural example of a sealant according to a twenty-second practical example.

FIG. 57E is a cross-sectional diagram showing a structural example of a sealant according to a twenty-third practical example.

FIG. 57F is a cross-sectional diagram showing a structural example of a sealant according to a twenty-fourth practical example.

FIG. 58A is a cross-sectional diagram showing the state before curing a bonding part, in a diagram showing a process of forming the sealant according to the comparative example.

FIG. 58B is a cross-sectional diagram showing the state after curing a bonding part, in the diagram showing the process of forming the sealant according to the comparative example.

FIG. 59A is a cross-sectional diagram showing the state before curing a bonding part, in a diagram showing a process of forming the sealant according to the twenty-third practical example.

FIG. 59B is a cross-sectional diagram showing the state after curing a bonding part, in a diagram showing a process of forming the sealant according to the twenty-third practical example.

FIG. 60A is a cross-sectional diagram showing a structural example of a sealant according to a twenty-fifth practical example.

FIG. 60B is a cross-sectional diagram showing a structural example of a sealant according to a twenty-sixth practical example.

FIG. 60C is a cross-sectional diagram showing the state of the sealant according to the twenty-second practical example.

FIG. 61A is a diagram showing a variation of the structure of the sealed part, and is a cross-sectional diagram showing a structural example of a sealed part according to a twenty-seventh practical example.

FIG. 61B is a diagram showing a variation of the structure of the sealed part, and is a cross-sectional diagram showing a structural example of a sealed part according to a twenty-eighth practical example.

FIG. 61C is a diagram showing a variation of the structure of the sealed part, and is a cross-sectional diagram showing a structural example of a sealed part according to a twenty-ninth practical example.

FIG. 62A is a diagram showing other variation of the structure of the sealed part, and is a cross-sectional diagram showing a structural example of a sealed part according to a thirty practical example.

FIG. 62B is a diagram showing other variation of the structure of the sealed part, and is a cross-sectional diagram showing a structural example of a sealed part according to a thirty-first practical example.

FIG. 62C is a diagram showing other variation of the structure of the sealed part, and is a cross-sectional diagram showing a structural example of a sealed part according to a thirty-second practical example.

FIG. 63A is a diagram showing other variation of the structure of the sealed part, and is a cross-sectional diagram showing a structural example of a sealed part according to a thirty-third practical example.

FIG. 63B is a diagram showing other variation of the structure of the sealed part, and is a cross-sectional diagram showing a structural example of a sealed part according to a thirty-fourth practical example.

FIG. 63C is a diagram showing other variation of the structure of the sealed part, and is a cross-sectional diagram showing a structural example of a sealed part according to a thirty-fifth practical example.

FIG. 64A is a diagram showing other variation of the structure of the sealed part, and is a cross-sectional diagram showing a structural example of a sealed part according to a thirty-six practical example.

FIG. 64B is a diagram showing other variation of the structure of the sealed part, and is a cross-sectional diagram showing a structural example of a sealed part according to a thirty-seventh practical example.

FIG. 64C is a diagram showing other variation of the structure of the sealed part, and is a cross-sectional diagram showing a structural example of a sealed part according to a thirty-eighth practical example.

FIG. 65A is a diagram showing other variation of the structure of the sealed part, and is a cross-sectional diagram showing a structural example of a sealed part according to a thirty-ninth practical example.

FIG. 65B is a diagram showing other variation of the structure of the sealed part, and is a cross-sectional diagram showing a structural example of a sealed part according to a forty practical example.

FIG. 66A is a diagram showing other variation of the structure of the sealed part, and is a cross-sectional diagram showing a structural example of a sealed part according to a forty-first practical example.

FIG. 66B is a diagram showing other variation of the structure of the sealed part, and is a cross-sectional diagram showing a structural example of a sealed part according to a forty-second practical example.

FIG. 67A is a diagram showing other variation of the structure of the sealed part, and is a cross-sectional diagram showing a structural example of a sealed part according to a forty-third practical example.

FIG. 67B is a diagram showing other variation of the structure of the sealed part, and is a cross-sectional diagram showing a structural example of a sealed part according to a forty-fourth practical example.

### DESCRIPTION OF EMBODIMENTS

Next, certain embodiments of the invention will be described with reference to drawings. In the description of the following drawings, the identical or similar reference numeral is attached to the identical or similar part. However, it should be noted that the drawings are schematic and the relation between thickness and the plane size and the ratio of the thickness of each layer differs from an actual thing. Therefore, detailed thickness and size should be determined in consideration of the following explanation. Of course, the part from which the relation and ratio of a mutual size differ also in mutually drawings is included.

Moreover, the embodiments shown hereinafter exemplify the apparatus and method for materializing the technical idea of the present invention; and the embodiments of the present invention does not specify the material, shape, structure, placement, etc. of component parts as the following. Various changes can be added to the technical idea of the present invention in scope of claims. In DSCs according to the following embodiments, “transparent” is defined as that whose transmissivity is not less than approximately 50%. In the DSCs according to the embodiments, the “transparent” is used for the purpose of being transparent and colorless with respect to visible light. The visible light is equivalent to light having a wavelength of approximately 360 nm to approximately 830 nm and energy of approximately 3.4 eV to approximately 1.5 eV, and it can be said that it is transparent if the transmission rate is not less than 50% in such a region.

### First Embodiment

### Dye-Sensitized Solar Cells

FIG. 1 shows a schematic cross-sectional structure of DSCs 200 according to a first embodiment.

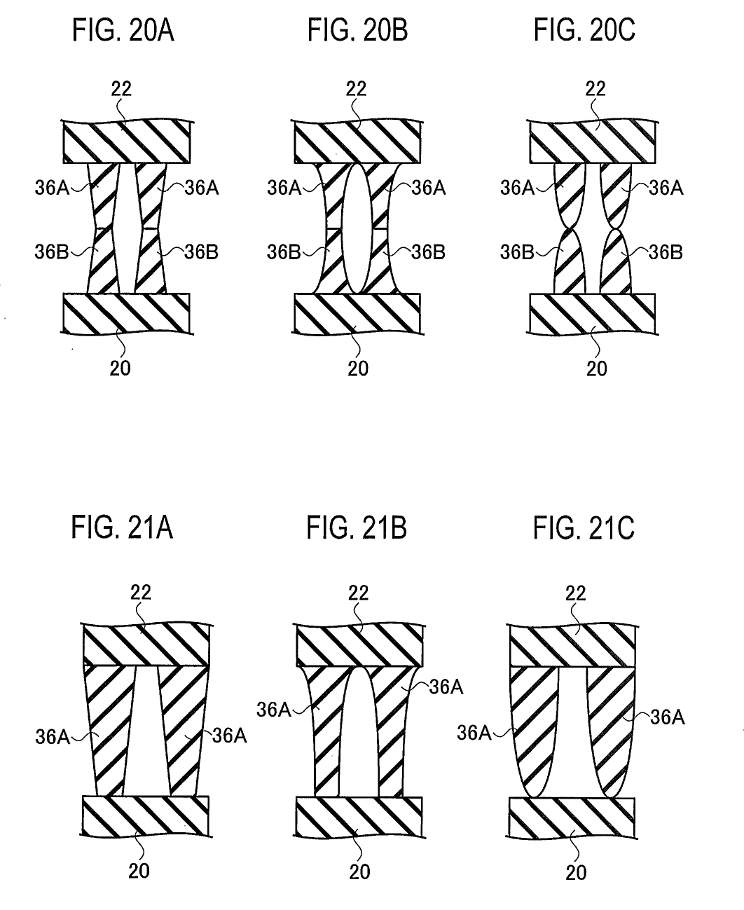

More specifically, a sealed part 36 shown in FIG. 1 is provided with structure as shown, for example in FIGS. 20-26. Further details will be described later.

The DSCs 200 according to the first embodiment include: a first substrate 20; a first electrode 10 disposed on the first substrate 20; a porous semiconductor layer 12 disposed on the first electrode 10 and including semiconductor fine particles and dye molecules; an electrolysis solution 14 contacted with the porous semiconductor layer 12 and dissolving a redox electrolyte in a solvent; a second electrode 18 contacted with the electrolysis solution 14; a second substrates 22 disposed on the second electrode 18; and a sealed part 36 for sealing the electrolysis solution 14, the sealed part 36 disposed between the second substrate 20 and the first substrate 22, wherein the sealed part 36 is configured to which a burning body of a paste containing a glass frit is fusion bonded.

In this case, the glass frit can be composed of Bi—B—Si based powdered oxide. The glass frit composed of the Bi—B—Si based oxide has the property of absorbing infrared rays, producing heat, and fusing. Therefore, it is possible to be fusion bonded to the first substrate 20 and second substrate 22, etc. by irradiating a burning body of a paste containing the glass frit with infrared laser (for example, the wavelength is 1064 nm), as described later.

The sealed part 36 may include at least one of a first base part 36B having a predetermined height, and a second base part 36A having a predetermined height. The first base part 36B is positioned in the first substrate 20 side, and is formed of a burning body of a paste containing a glass frit. The second base part 36A is positioned in the second substrate 22 side, and is formed of a burning body of a paste containing a glass frit.

Moreover, the first base part 36B and the second base part 36A are respectively formed in equal to or greater than in two pieces.

Moreover, the first base part 36B and the second base part 36A may be disposed so that a tip part of the first base part 36B and a tip part of the second base part 36A are opposed to each other.

Moreover, the first base part 36B and the second base part 36A may be disposed so that a position of the tip part of the first base part 36B and a position of the tip part of the second base part 36A are in a staggered configuration.

Moreover, the first base part 36B and the second base part 36A may have a taper shape to which a cross-sectional area becomes smaller as the first base part 36B and the second base part 36A are away from the first substrate 20 and the second substrate 22.

Moreover, the first base part 36B and the second base part 36A may have a wedge shape in cross section.

Moreover, the first base part 36B and the second base part 36A may be fusion bonded to the first substrate 20 or the second substrate 22 by irradiating a contact part with the first substrate 20 or the second substrate 22 with infrared laser.

Moreover, the first base part 36B and the second base part 36A may be fusion bonded to each other by irradiating a contact part between the first base part 36B and the second base part 36A with infrared laser.

As shown in FIG. 1, a working electrode 100 applied to the DSCs 200 according to the first embodiment includes: a transparent electrode 10 disposed on the glass substrate 20; and a porous semiconductor layer 12 disposed on the transparent electrode 10.

As shown in FIG. 1, the DSCs 200 according to the first embodiment includes: a glass substrate 20; a transparent electrode 10 disposed on the glass substrate 20; a porous semiconductor layer 12 disposed on the transparent electrode 10; and an electrolysis solution 14 contacted with the porous semiconductor layer 12, and including an electrolyte made by mixing a plurality of types of redox electrolytes with a solvent.

A cathode electrode 3K used as a cathode of the DSCs 200 is formed on the transparent electrode 10 of the first substrate 20.

An anode electrode 3A used as an anode of the DSCs 200 is formed on the second electrode 18 of the second substrate 22.

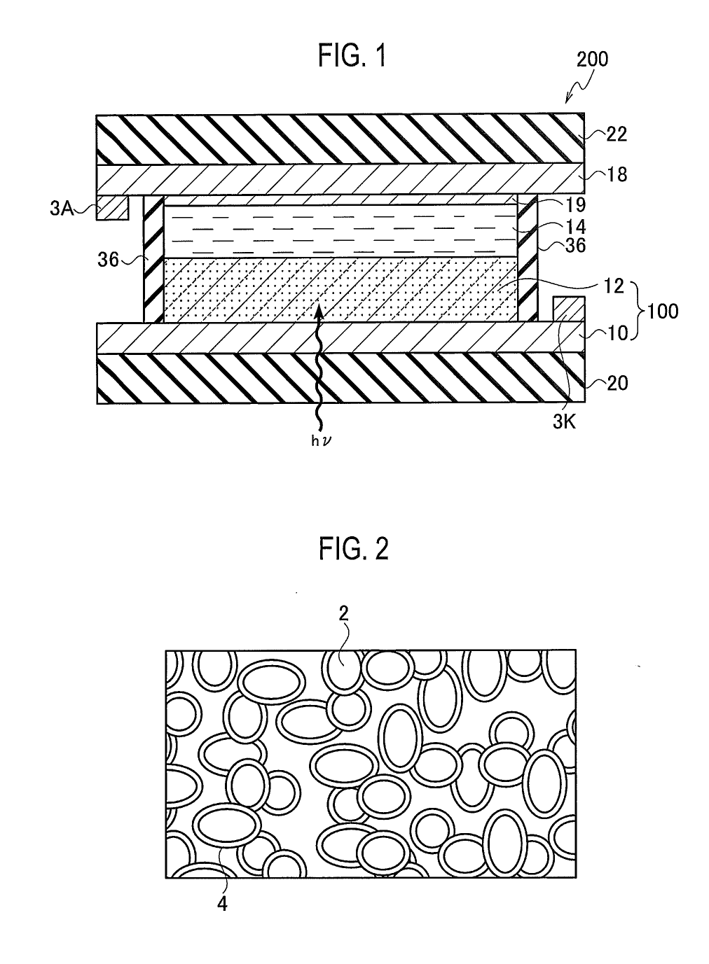

Moreover, as shown in FIG. 1, the DSCs 200 according to a first embodiment includes: a first substrate 20; a first electrode 10 disposed on the first substrate 20; a porous semiconductor layer 12 including semiconductor fine particles 2 and dye molecules 4 as shown in FIG. 2, and disposed on the first electrode 10; an electrolysis solution 14 contacted with the porous semiconductor layer 12 and dissolving a redox electrolyte in a solvent; a second electrode (counter electrode) contacted with the electrolysis solution 14; a second substrates 22 disposed on the second electrode 18; a catalyst layer 19 disposed on a surface of the electrolysis solution 14 side of the second electrode 18 contacted with the electrolysis solution 14; and a sealed part (separator) 36 disposed between the first substrate 20 and the second substrate 22, is configured to which a burning body of a paste containing a glass frit for sealing the electrolysis solution 14 is fusion bonded.

The catalyst layer 19 can be composed of Pt, carbon, or a conductive polymer, for example.

Moreover, the catalyst layer may be composed of activated carbon including fine particles of a metal oxide of TiO₂, ZnO, SnO₂, and WO₃, etc. Since the fine particles of the metal oxide of TiO₂, ZnO, SnO₂, WO₃, etc. are relatively inexpensive compared with a platinum (Pt), and it is not necessary to use a vacuum film formation method at the time of forming a Pt film, thereby forming the film under the application of printing methods, e.g. a screen printing, as describe later, fabrication costs can be reduced, thereby significantly reducing fabrication unit costs of the DSCs.

Furthermore, since the catalyst layer 19 includes conductive polymers (PEDOT: PSS etc.) in an activated carbon, a conductivity between particles can be improved, and thereby manufacturing costs can be inexpensive, and a power generation characteristics can be improved, also in this case.

The sealed part 36 is composed so that a burning body of a paste containing a glass frit is fusion bonded, and the glass frit is composed of powdered Bi—B—Si based oxide.

Then, the sealed part 36 is fusion bonded to the first substrate 20 or the second substrate 22, etc. by irradiating the burning body of the paste containing the glass frit with infrared laser, e.g. a wavelength of 1064 nm.

The height of the sealed part 36 may be 30-50 μm, for example. The width of the sealed part 36 may be approximately 0.2-0.5 mm, for example.

Here, temperature resistance and moisture resistance of the burning body of the paste containing the glass frit is more excellent than that of an ultraviolet curing resin, and tolerance for the electrolysis solution 14 is also excellent as compared with that of the ultraviolet curing resin.

Therefore, the DSCs 200 according to the first embodiment configured so that the burning body of the paste containing the glass frit is fusion bonded to the sealed part 36 can significantly improve durability regarding keeping of power generation characteristics and electrolyte holding ability as compared with the DSCs in which a sealed part is composed of an ultraviolet curing resin. More specifically, regarding the DSCs 200 according to the first embodiment, there is obtained an excellent result about keeping of the power generation characteristic and the electrolyte holding ability, in environmental tests of 60 and 70 degrees C./90% RH.

Moreover, since the glass frit of which electrolyte tolerance is high and the electrolyte holding ability is excellent is used for the sealed part 36, the width of the sealed part 36 (sealing line width) can be approximately 0.2-0.5 mm, and narrow picture frame can be achieved as compared with conventionally.

Moreover, since the sealed part 36 performs local heating and is fusion bonded to the first substrate 20 or the second substrate 22, etc. by irradiating the burning body of the paste containing the glass frit with infrared laser of which the wavelength of 1064 nm, for example, its adhesive strength is higher, thereby effectively reducing occurrence of break in the sealed part etc.

According to a process of forming the sealed part 36 by fusing the burning body of the paste containing the glass frit, the process number can be reduced as compared with a process of forming the sealed part using the ultraviolet curing resin, thereby reducing production time and manufacturing costs.

The first substrate 20 and the second substrate 22 can be formed of a glass substrate etc., for example.

Moreover, a flexible plastic substrate can also be used for the first substrate 20 and the second substrate 22. In this case, TiO2 paste which can be annealed at equal to or less than 200 degrees C. is used as TiO₂ paste which composes the porous semiconductor layer.

The first electrode 10 is formed of transparent electrodes, e.g. FTO, ZnO, ITO, or SnO₂, for example. The first substrate 20 may also be an FTO substrate, metal grid electrode, or the above-mentioned complex substrate by processing an electrode on the first substrate 20.

The porous semiconductor layer 12 can be formed using screen printing technology, spin coat technology, dipping, spray coat technology, etc., for example.

The porous semiconductor layer 12 may be formed of materials, e.g. TiO₂, ZnO, WO₃, InO₃, ZrO₂, Ta₂O₃, Nb₂O₃, or SnO₂. In particular, inexpensive TiO₂ (an anatase type, a rutile type) is mainly used for the porous semiconductor layer 12 from the viewpoint of an efficiency.

A schematic structure showing the semiconductor fine particles 2 of the porous semiconductor layer 12 shown in FIG. 1 is illustrated as shown in FIG. 2. As shown in FIG. 2, in the porous semiconductor layer 12, the semiconductor fine particles 2 composed of TiO₂ etc. form a complicated network by being combined with each other. The dye molecules 4 are adsorbed on a surface of the semiconductor fine particles 2. In the porous semiconductor layer 12, there are plenty of not more than 100-nm fine pores.

### (Operational Principle)

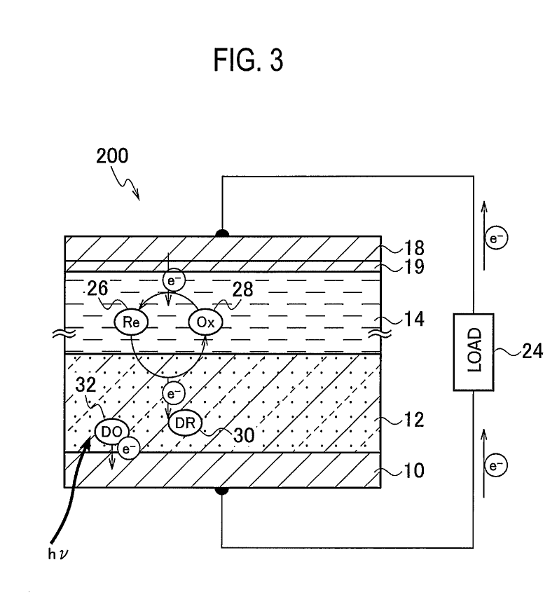

The operational principle of the DSCs 200 according to the first embodiment is illustrated as shown in FIG. 3.

Electromotive force is generated since the following reactions (a) to (d) occur continuously, and then an electric current conducts to a load 24.

(a) Dye molecules 32 absorb the photons (hν), the electrons (e⁻) are released, and then the dye molecules 32 are become to oxidant DO.
(b) Redox electrolyte 26 of reductant illustrated with Re is diffused in the porous semiconductor layer 12, and is close to the dye molecules 32 of the oxidant illustrated with DO.
(c) The electrons (e⁻) are supplied to the dye molecules 32 from the redox electrolyte 26. The redox electrolyte 26 becomes a redox electrolyte 28 of the oxidant illustrated with Ox, and the dye molecules 32 become a reduced dye molecules 30 illustrated with DR.
(d) The redox electrolyte 28 is diffused in a direction of the catalyst layer 19, the electrons are supplied from the catalyst layer 19 thereto, and then becomes the reductant redox electrolytes 26 illustrated with Re.

The redox electrolyte 26 needs to be close near the dye molecules 32, being diffused into the complicated space in the porous semiconductor layer 12.

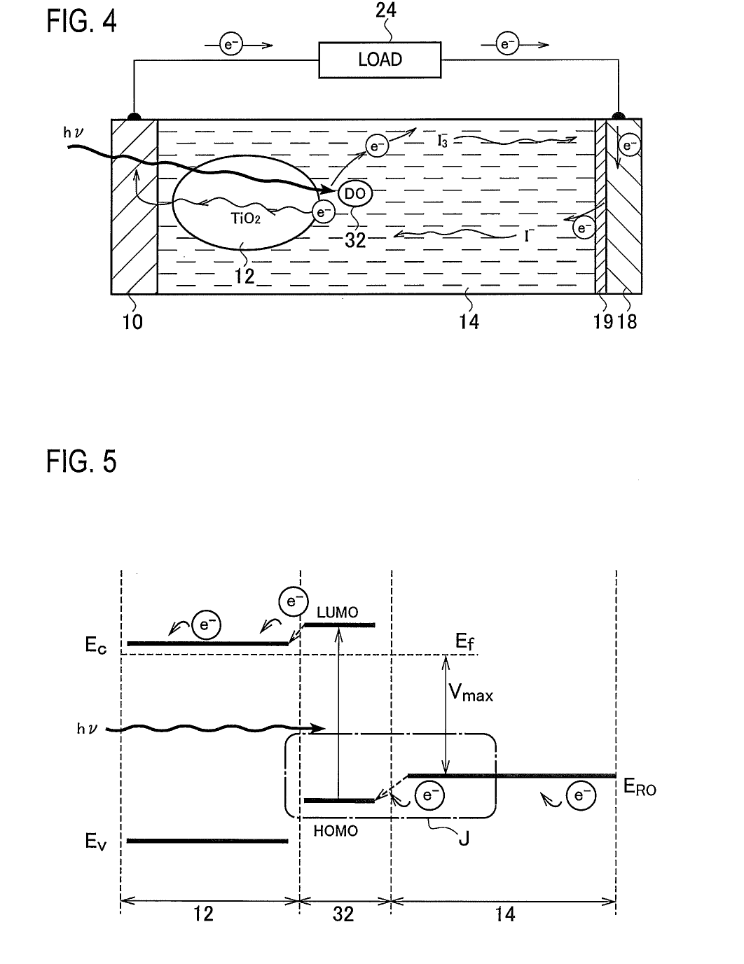

Moreover, the operational principle based on a charge exchange reaction in the electrolysis solution 14 of the DSCs 200 according to the first embodiment is illustrated as shown in FIG. 4.

First of all, if light is irradiated from an outside, the photons (hν) reacts with the dye molecules 32, and then the dye molecules 32 shifts from the ground state to the excited state. The excited electron (e⁻) generated at this time is injected into a conduction band of the porous semiconductor layer 12 composed of TiO₂. The electron (e⁻) which conducts into the porous semiconductor layer 12 conducts from the transparent electrode 10 into the load 24 of the external circuit, and shifts to the second electrode 18. The electron (e⁻) injected into the electrolysis solution 14 from the second electrode 18 is subjected to charge exchange with an iodine redox electrolyte (I⁻/I₃⁻) in the electrolysis solution 14. The iodine redox electrolyte (I⁻/I3⁻) is diffused into the electrolysis solution 14, and then re-reacts with the dye molecules 32. In this case, the charge exchange reaction proceeds in accordance with 3I⁻→I₃⁻+2e⁻ in the dye molecules surface, and proceeds in accordance with I₃⁻+2e⁻→3I⁻ in the second electrode 18.

Acetonitrile is used for the electrolysis solution 14 as a solvent, for example, and iodine is present as the iodine redox electrolyte I3− in the electrolysis solution 14 as an electrolyte in this case, for example. Furthermore, Iodide salt (lithium iodide, potassium iodide, etc.) as an electrolyte is present as the iodine redox electrolyte I⁻ in the electrolysis solution 14, for example. Moreover, in the electrolysis solution 14, an additive agent (e.g., tert-butyl pyridine (TBP)) may be applied as a reverse electron transfer inhibiting solution.

The electrolysis solution 14 can be composed by dissolving the solute and the additive agent in the solvent (acetonitrile). The above-mentioned materials are applicable to a wet DSC etc., and composite materials are different therefrom when using the ambient temperature molten salt (ionic liquid) and the solid electrolyte.

In the DSCs 200 according to the first embodiment, the solvent is a liquid for dissolving electrolytes and additive agents described later, and is preferable to have high chemical stability with high boiling point, and to have high dielectric constant (the electrolyte can be completely dissolved) and low viscosity. The solvent may be composed of acetonitrile, propylene carbonate, y-butyrolactone (kigoudayp), methoxyacetonitrile, propionitrile, ethylene carbonate, propylene carbonate, etc., for example.

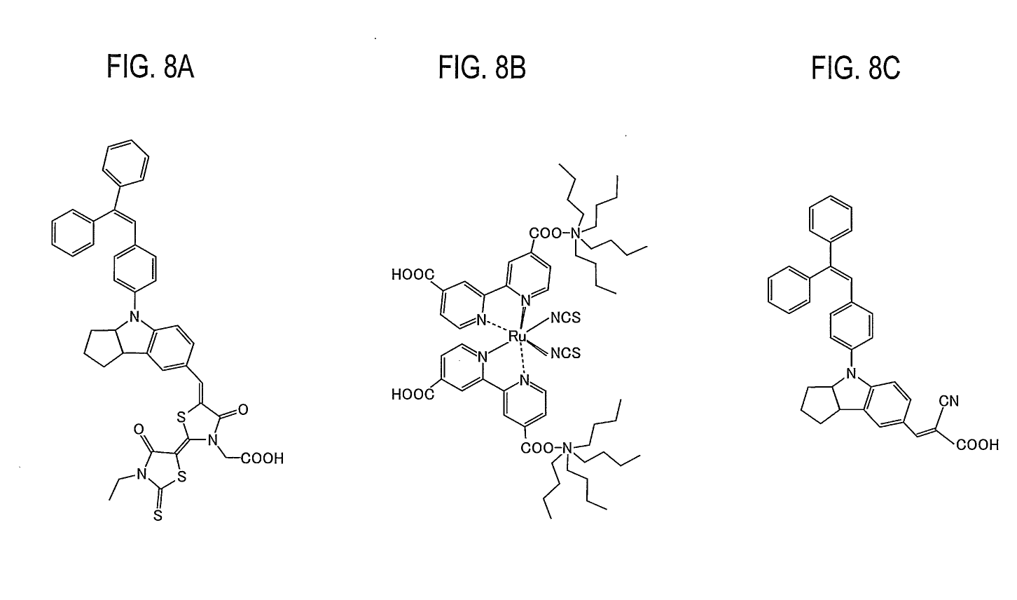

An indoline based dye (D149) of which the chemical structure formula is shown in FIG. 8A, a red die of which the chemical structure formula is shown in FIG. 8B (N719), D131 of which the chemical structure formula is shown in FIG. 8C, a black die (N749), etc. are applicable to the dyes.

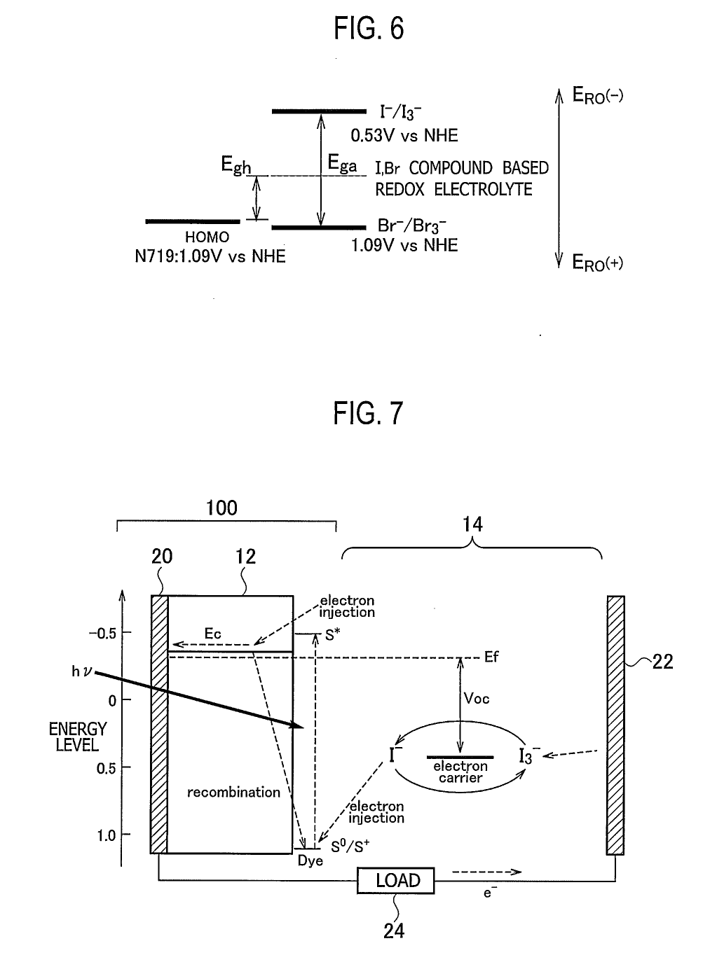

In the DSCs 200 according to the first embodiment, an energy potential diagram between the porous semiconductor layer (12)/the dye molecules (32)/the electrolysis solution (14) is illustrated as shown in FIG. 5. Moreover, an energy potential diagram between the dye molecules (32)/the electrolysis solution (14), which is an enlarged drawing of a portion J shown in FIG. 5, is illustrated as shown in FIG. 6.

If light is irradiated from an outside, the dye molecules 32 shifts from the ground state HOMO to the excited state LUMO, in accordance with the photons (hν). The excited electron (e⁻) generated at this time is injected into a conduction band of the porous semiconductor layer 12 composed of TiO₂. The electron (e⁻) which conducts into the porous semiconductor layer 12 conducts from the transparent electrode 10 into the load 24 of the external circuit, and shifts to the second electrode 18. The electron (e⁻) injected into the electrolysis solution 14 from the catalyst layer 19 is subjected to charge exchange with a redox electrolyte in the electrolysis solution 14. The redox electrolyte is diffused into the electrolysis solution 14, and reduces the dye molecules 32.

The potential difference between the redox level E_{RO} of the electrolysis solution 14 and the Fermi level E_{f} of the porous semiconductor layer 12 is the maximal electromotive force V_{MAX}. The value of the maximal electromotive force V changes depending on the redox electrolytes of the electrolysis solution 14. The maximal electromotive force V is 0.9V (I, N719), for example, in the case of the single-based redox electrolyte (iodine redox electrolyte). As shown in FIG. 6, if the electrolysis solution 14 includes an iodine-bromine compound based redox electrolyte, the redox potential of the compound based redox electrolyte can be adjusted to any values within a range between the redox potential of the iodine redox electrolyte and the redox potential of the bromine redox electrolyte by adjusting the mixing ratio thereof.

FIG. 7 shows an energy level of each component and a power generation cycle, in the DSCs according to the first embodiment. In FIG. 7, if light is irradiated from an outside, with the photons (hν), the electrons which are present in a valence band S⁰/S⁺ of dyes are excited in conducting sleeve S*, and then is subjected to electron injection into a conduction band E_{C} of the porous semiconductor layer 12. A part of the electrons electron-injected into the conduction band E_{C} are recombined, and is shifted to the valence band S⁰/S⁺ of the dyes. The electron (e⁻) which conducts into the porous semiconductor layer 12 conducts from the transparent electrode 10 into the load 24 of the external circuit, and shifts to the second electrode 18. The electron (e⁻) injected into the electrolysis solution 14 from the catalyst layer 19 is subjected to charge exchange with a redox electrolyte in the electrolysis solution 14. The redox electrolyte is diffused into the electrolyte 14, and the dye molecules 32 are reduced in the valence band S⁰/S⁺ of the dyes by the electron injection. The potential difference V_{OC} between the redox level E_{RO} of the electrolysis solution 14 and the Fermi level E_{f} of the porous semiconductor layer 12 is the maximal electromotive force V_{MAX}.

### (Formation Process of Sealed Part)

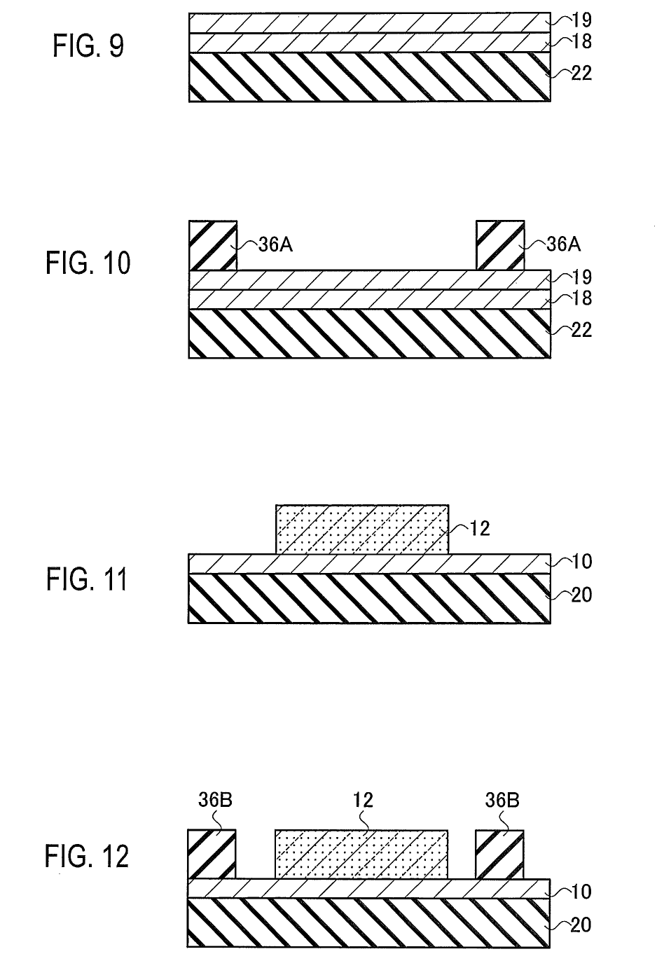

A process of forming the sealed part will now be explained with reference to FIGS. 9-18.

First, as shown in FIG. 9, the second electrode 18 and the catalyst layer 19 are formed on the second substrate 22 composed of a glass substrate, etc. The catalyst layer 19 is formed of Pt, carbon, or a conductive polymer, for example.

Subsequently, as shown in FIG. 10, the second base part 36A is formed on the catalyst layer 19. The second base part 36A is formed by coating a paste containing the glass frit using a screen printing method, etc. The glass frit is composed of a powdered Bi—B—Si based oxide.

Next, as shown in FIG. 11, the first electrode 10 and the porous semiconductor layer 12 are formed on the first substrate 20 composed of a glass substrate, etc.

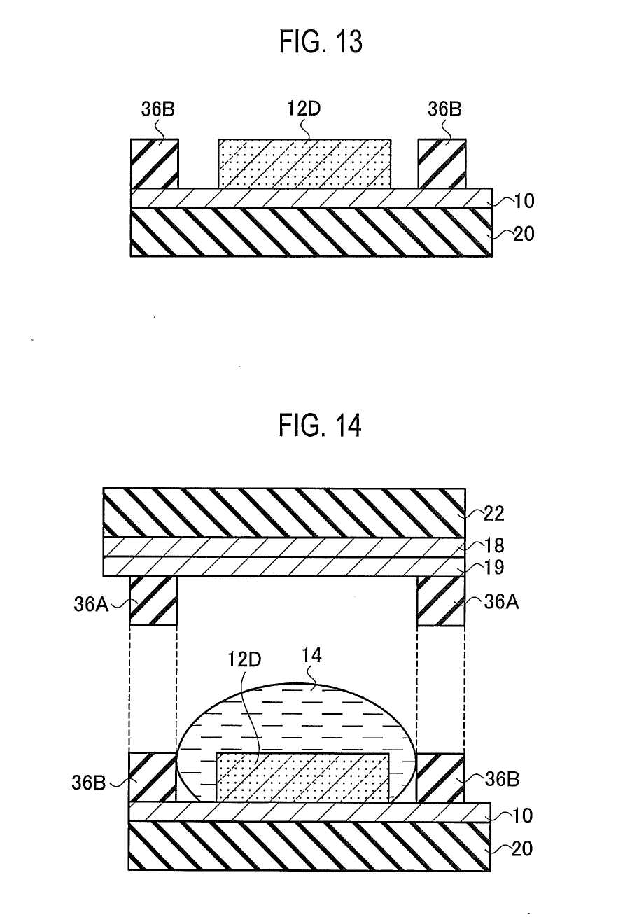

Then, as shown in FIG. 12, the first base part 36B is formed on the first electrode 10. The first base part 36B is formed by coating a paste containing the glass frit using a screen printing method, etc. The glass frit is composed of a powdered Bi—B—Si based oxide. Subsequently, as shown in FIG. 13, it changes into a state where a dye is adsorbed to the porous semiconductor layer 12D.

Next, as shown in FIG. 14, it changes into a state where the electrolysis solution 14 is dropped on the first substrate 20 side, and the second substrate 22 is opposed to the first substrate 20 in a state where the second base part 36A points downward.

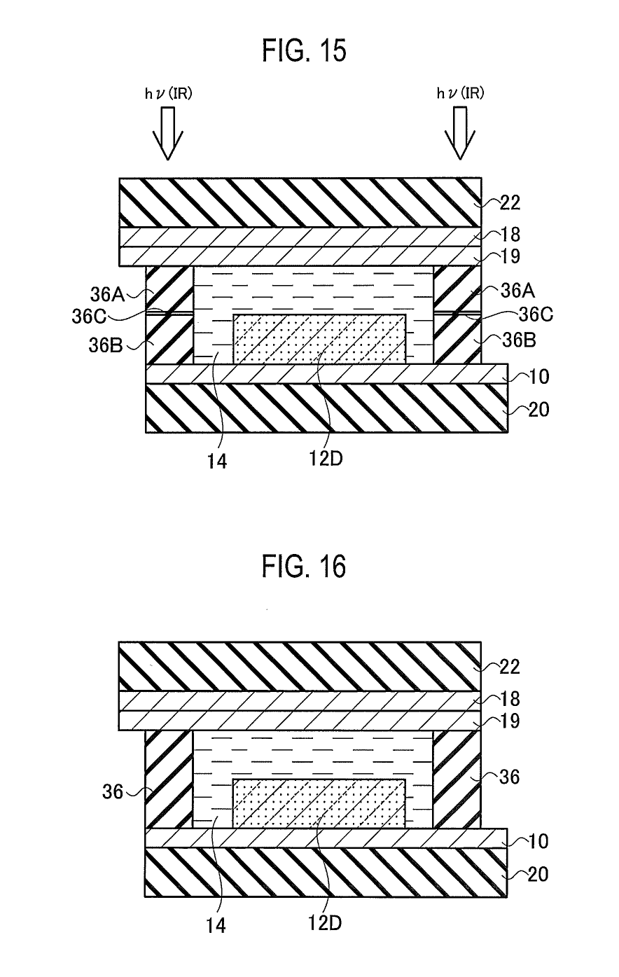

Then, as shown in FIG. 15, in a state of contacting the first base part 36B and the second base part 36A so as to be opposed to each other via the contact part 36C from the state of FIG. 14, a contact part 36C therebetween is irradiated with infrared laser (hν (IR)). In an example shown in FIG. 15, the contact part 36C is irradiated with the infrared laser (hν (IR)) from the second substrate 22 side.

Accordingly, the first base part 36B and the second base part 36A composed of the burning body of the paste containing the glass frit are heated locally to be melted, and are fusion bonded to each other via the contact part 36C, thereby forming the sealed part 36 (refer to FIG. 16).

The sealed part 36 formed in this manner has high adhesive strength, thereby effectively reducing occurrence of break in the sealed part, etc.

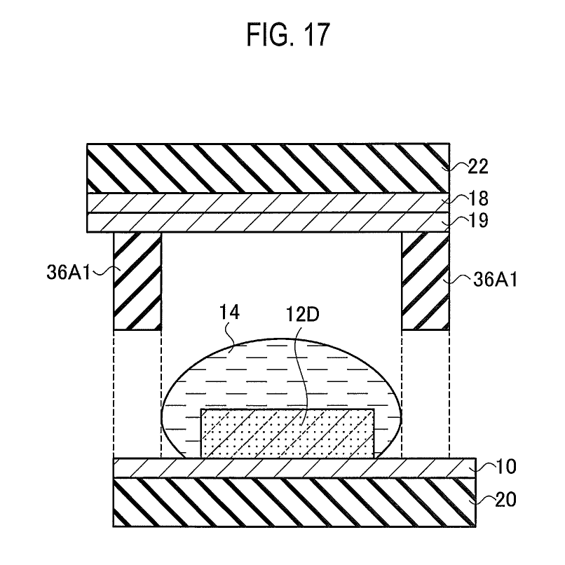

Moreover, as shown in FIG. 17, the second base part 36A1 may be formed only on the second substrate 22 side.

In this case, a tip of the second base part 36A1 is contacted with the first electrode 10 of the first substrate 20 on which the electrolysis solution 14 is dropped.

Then, the contact part is fusion bonded by irradiating the contact part between the second base part 36A1 and the first electrode 10 with infrared laser from the first substrate 20 side or the second substrate 22 side, for example.

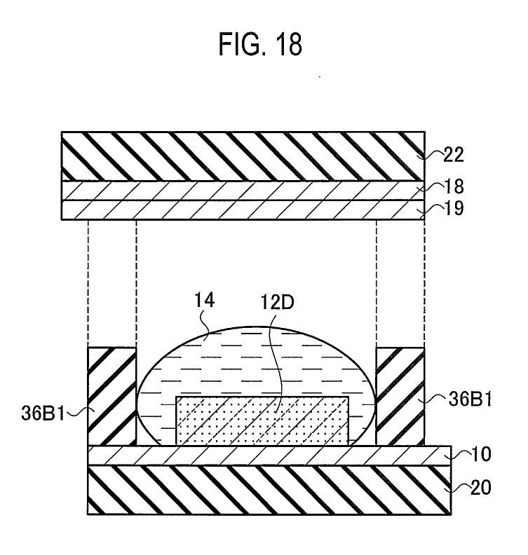

Moreover, as shown in FIG. 18, the first base part 36B1 may be formed only on the first substrate 20 side.

In this case, a tip of the first base part 36B1 is contacted with the catalyst layer 19 at the side of the second substrate 22.

Then, the contact part is fusion bonded by irradiating the contact part between the first base part 36B1 and the catalyst layer 19 with infrared laser from the first substrate 20 side or the second substrate 22 side, for example.

### (Variation of Structure of Sealed Part)

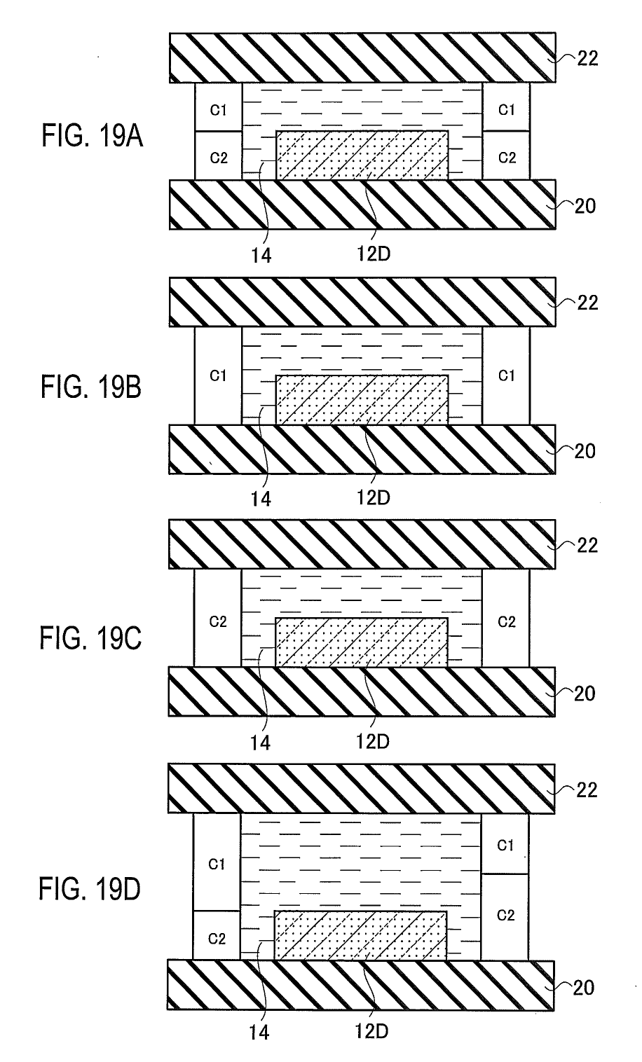

A variation of a structure of the sealed part will now be explained with reference to FIG. 19.

FIG. 19A shows a structure in which the first base part C2 and the second base part C1 formed in the same height are fusion bonded so as to be opposed to each other.

FIG. 19B shows a structure in which the second base part C1 formed in the second substrate 22 side is fusion bonded to the first substrate 20.

FIG. 19C shows a structure in which the first base part C2 formed in the first substrate 20 side is fusion bonded to the second substrate 22.

FIG. 19D shows a structure in which the first base part C2 and the second base part C1 formed in mutually different heights are fusion bonded so as to be opposed to each other.

### (Practical Examples of Sealed Part)

FIG. 20A is a sectional view showing a structural example of the sealed part according to a first practical example. As shown in FIG. 20A, in the present practical example, a sectional shape of the first base part 36B and the second base part 36A each formed in two pieces is a wedge shape.

FIG. 20B is a sectional view showing a structural example of the sealed part according to a second practical example. As shown in FIG. 20B, in the present practical example, a sectional shape of the first base part 36B and the second base part 36A each formed in two pieces is a taper shape to which cross-sectional area becomes smaller as being away from the first substrate 20 and the second substrate 22.

FIG. 20C is a sectional view showing a structural example of the sealed part according to a third practical example. As shown in FIG. 20C, in the present practical example, a sectional shape of the first base part 36B and the second base part 36A each formed in two pieces is a spindle-formed taper shape to which cross-sectional area becomes smaller as being away from the first substrate 20 and the second substrate 22.

FIG. 21A is a sectional view showing a structural example of the sealed part according to a fourth practical example. As shown in FIG. 21A, in the present practical example, a sectional shape of the second base part 36A formed in two pieces is a wedge shape.

FIG. 21B is a sectional view showing a structural example of the sealed part according to a fifth practical example. As shown in FIG. 21B, in the present practical example, a sectional shape of the second base part 36A formed in two pieces is a taper shape to which cross-sectional area becomes smaller as being away from the second substrate 22.

FIG. 21C is a sectional view showing a structural example of the sealed part according to a sixth practical example. As shown in FIG. 21C, in the present practical example, a sectional shape of the second base part 36A formed in two pieces is a spindle-formed taper shape to which cross-sectional area becomes smaller as being away from the second substrate 22.

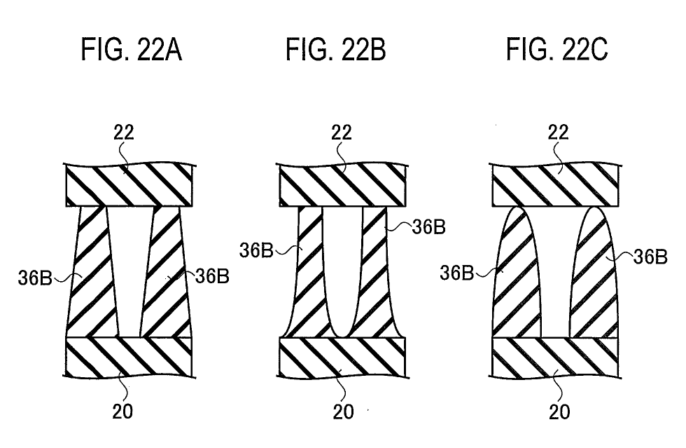

FIG. 22A is a sectional view showing a structural example of the sealed part according to a seventh practical example. As shown in FIG. 22A, in the present practical example, a sectional shape of the first base part 36B formed in two pieces is a wedge shape.

FIG. 22B is a sectional view showing a structural example of the sealed part according to an eighth practical example. As shown in FIG. 22B, in the present practical example, a sectional shape of the first base part 36B formed in two pieces is a taper shape to which cross-sectional area becomes smaller as being away from the first substrate 20.

FIG. 22C is a sectional view showing a structural example of the sealed part according to a ninth practical example. As shown in FIG. 22C, in the present practical example, a sectional shape of the first base part 36B formed in two pieces is a spindle-formed taper shape to which cross-sectional area becomes smaller as being away from the first substrate 20.

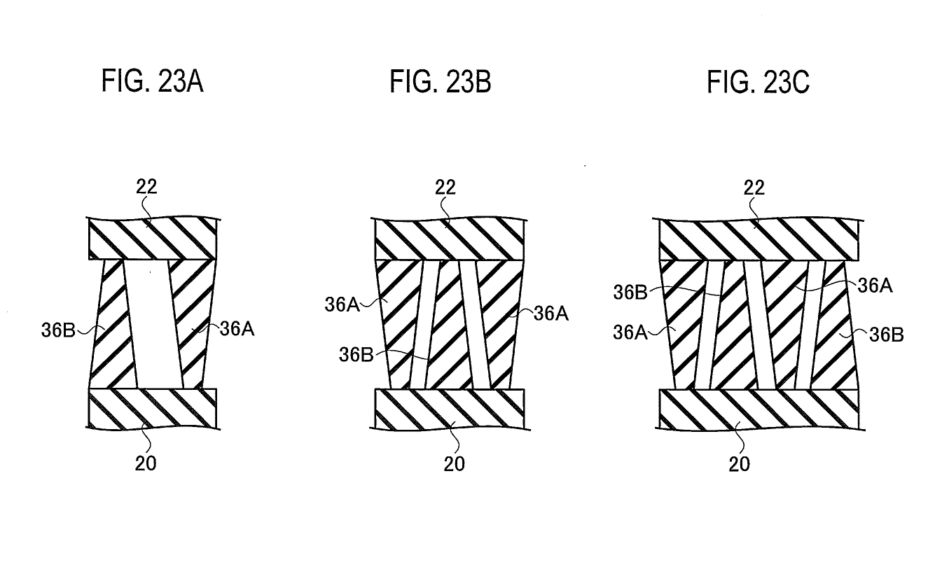

FIG. 23A is a sectional view showing a structural example of the sealed part according to a tenth practical example. As shown in FIG. 23A, in the present practical example, a sectional shape of the first base part 36B and the second base part 36A is a staggered wedge shape.

FIG. 23B is a sectional view showing a structural example of the sealed part according to an eleventh practical example. As shown in FIG. 23B, in the present practical example, a sectional shape of the second base part 36A formed in two pieces and the first base part 36B inserted between the second base parts 36A via predetermined space is a staggered wedge shape.

FIG. 23C is a sectional view showing a structural example of the sealed part according to a twelfth practical example. As shown in FIG. 23C, in the present practical example, a sectional shape of the first base part 36B and the second base part 36A each formed in two pieces via predetermined space one after the other is a staggered wedge shape.

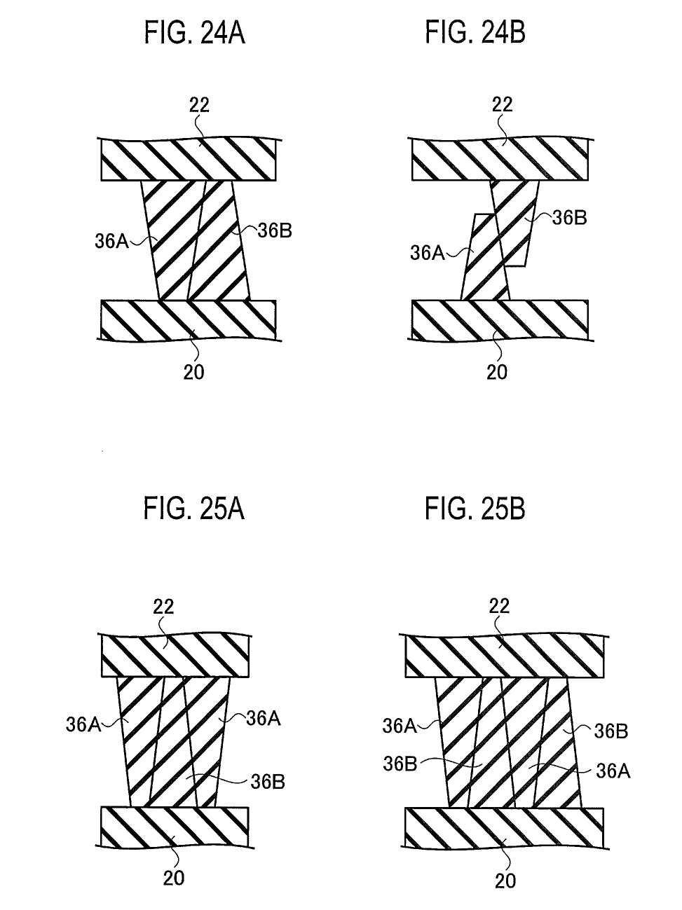

FIG. 24A is a sectional view showing a structural example of the sealed part according to a thirteenth practical example. As shown in FIG. 24A, in the present practical example, a sectional shape of the first base part 36B and the second base part 36A is a staggered wedge shape, and each surface thereof in vertical direction is mutually contacted. In this case, the first base part 36B and the second base part 36A are mutually fusion bonded also at the contact surface under irradiation of infrared laser, thereby being bonded to each other more strongly.

FIG. 24B is a sectional view showing a structural example of the sealed part according to a fourteenth practical example. As shown in FIG. 24B, in the present practical example, a sectional shape of the first base part 36B and the second base part 36A is a staggered wedge shape, and a part of each surface thereof in vertical direction is mutually contacted. In this case, the first base part 36B and the second base part 36A are mutually fusion bonded at the contact surface under irradiation of infrared laser.

FIG. 25A is a sectional view showing a structural example of the sealed part according to a fifteenth practical example. As shown in FIG. 25A, in the present practical example, a sectional shape of the second base part 36A formed in two pieces and the first base part 36B inserted and contacted between the second base parts 36A via predetermined space is a staggered wedge shape. In this case, the first base part 36B and the second base part 36A are mutually fusion bonded at the contact surface under irradiation of infrared laser, thereby being bonded to each other more strongly.

FIG. 25B is a sectional view showing a structural example of the sealed part according to a sixteenth practical example. As shown in FIG. 25B, in the present practical example, a sectional shape of the second base part 36A and the first base part 36B each formed in two pieces is a staggered wedge shape, and each surface thereof is contacted with each other. In this case, the first base part 36B and the second base part 36A are mutually fusion bonded at the contact surface under irradiation of infrared laser, thereby being bonded to each other more strongly.

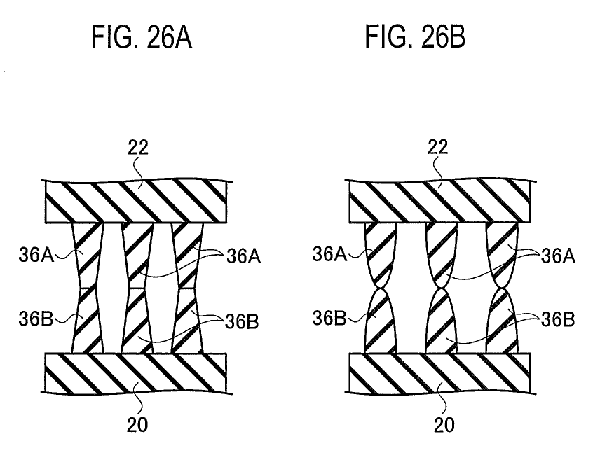

FIG. 26A is a sectional view showing a structural example of the sealed part according to a seventeenth practical example. As shown in FIG. 26A, in the present practical example, a sectional shape of the first base part 36B and the second base part 36A each formed in three pieces is a taper shape to which cross-sectional area becomes smaller as being away from the first substrate 20 and the second substrate 22.

FIG. 26B is a sectional view showing a structural example of the sealed part according to an eighteenth practical example. As shown in FIG. 26B, in the present practical example, a sectional shape of the first base part 36B and the second base part 36A each formed in three pieces is a spindle-formed taper shape to which cross-sectional area becomes smaller as being away from the first substrate 20 and the second substrate 22.

### (Examples of Serial Arrangement)

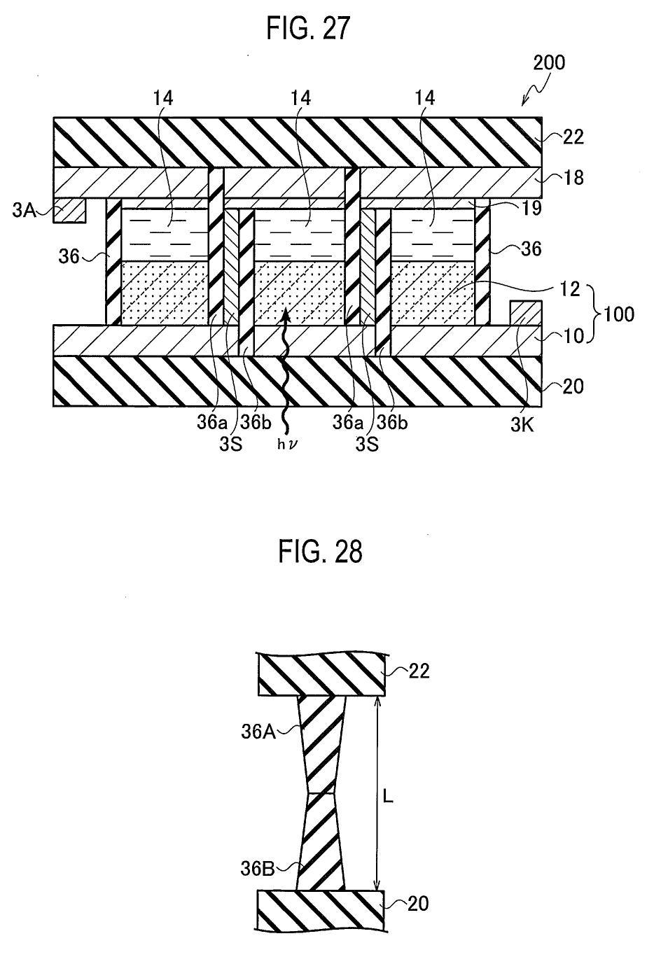

As shown in FIG. 27, a schematic cross-sectional structure of the DSCs 200 having serial structure has a structure of building three cells between the first substrate 20 and the second substrate 22. Duplicated descriptions are omitted, attaching the same reference numeral to the same structure as FIG. 1.

The sealed part 36, 36a, 36b may be a structure in the above-mentioned variation of the sealed part, or a structure in the above-mentioned practical examples of the sealed part.

As shown in FIG. 27, the DSCs 200 according to the first embodiment having serial structure has a structure of partitioning between each cell with the sealed parts 36a, 36b, and connecting between the transparent electrode 10 and the second electrode 18 with the electrode 3S formed between the sealed parts 36a, 36b. Accordingly, the DSCs 200 in which ion of the three adjoining cells are connected in series are composed.

Each sealed part 36, 36a, 36b is configured so that the burning body of the paste containing the glass frit is fusion bonded.

Accordingly, moisture or oxygen ingress into each cell can be effectively prevented, thereby improving the durability of the DSCs 200.

As shown in FIG. 28, the height L of the sealed part composed of the first base part 36B and the second base part 36A may be 30-50 μm, for example.

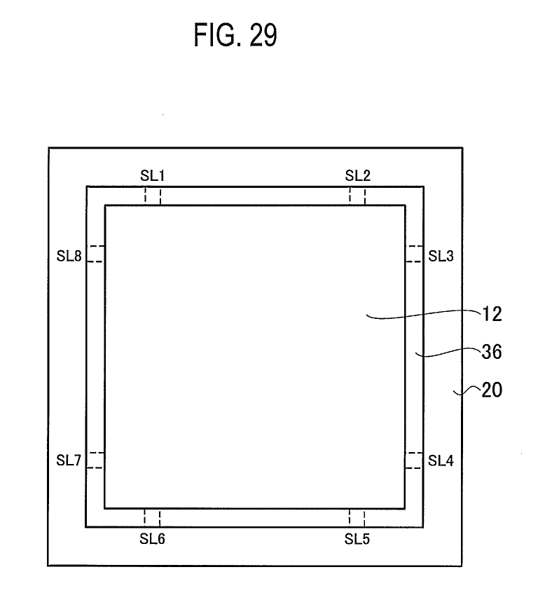

FIG. 29 is a diagram showing an example of structure of an air vent part formed in the sealed part 36. As shown in FIG. 29, eight slits SL1-SL8 as an air vent part are formed in the sealed part 36.

Accordingly, in the structure of the second base part 36A engaging with the first base part 36B to be bonded to each other, for example, as shown in FIGS. 25A and 25B, an air in a gap can be vented outside via the air vent part (slits SL1-SL8), thereby improving adhesion.

### (Fabrication Method)

A fabrication method of the DSCs according to the first embodiment includes: forming a first electrode 10 on a first substrate 20; forming a porous semiconductor layer 12 having semiconductor particulates on the first electrode 10; impregnating the porous semiconductor layer 12 with a dye solution to adsorb dye molecules 4; forming a second electrode 18 on a second substrate 22; coating a paste containing a glass frit on the first substrate 20 side and forming a first base part 368 having a predetermined height; coating a paste containing a glass frit on the second substrate 22 side and forming a second base part 36A having a predetermined height; annealing the first base part 36B and the second base part 36A; contacting the first base part 36B with the second base part 36A so that the first substrate 20 and the second substrate 22 are opposed to each other; irradiating a contact part between the first base part 36B and the second base part 36A infrared laser to be fusion bonded to each other; and injecting an electrolysis solution 14 in which a redox electrolyte is dissolved in a solvent between the first substrate 20 and the second substrate 22.

Moreover, another fabrication method of the DSCs according to the first embodiment includes: forming a first electrode 10 on a first substrate 20; forming a porous semiconductor layer 12 having semiconductor particulates on the first electrode 10; impregnating the porous semiconductor layer 12 with a dye solution to adsorb dye molecules 4; forming a second electrode 18 on a second substrate 22; coating a paste containing a glass frit on any one of the first substrate 20 side and the second substrate 22 side, and forming a first base part 36B or a second base part 36A having a predetermined height; annealing a first base part 36B or a second base part 36A; contacting the first base part 36B with the second base part 36A, or the second base part 36A with the first substrate 20 so that the first substrate 20 and the second substrate 22 are opposed to each other; irradiating a contact part between the first base part 36B and the second substrate 22, or a contact part between the second base part 36A and the first substrate 20 with infrared laser to be fusion bonded to each other; and injecting an electrolysis solution 14 in which a redox electrolyte is dissolved in a solvent between the first substrate 20 and the second substrate 22.

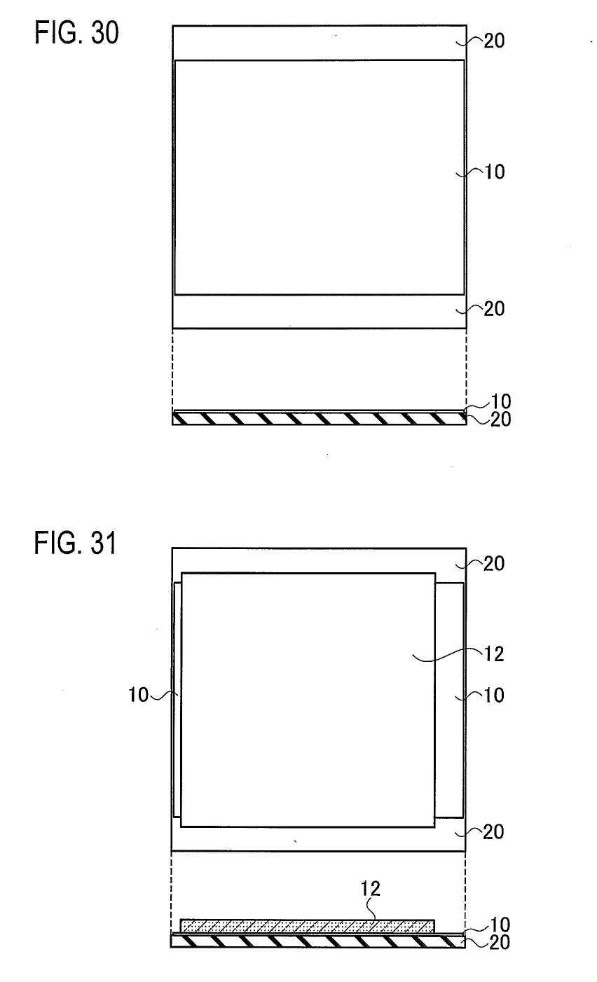

Here, there will be explained examples of the manufacturing method of the DSCs according to the first embodiment, with reference to FIGS. 30-35.

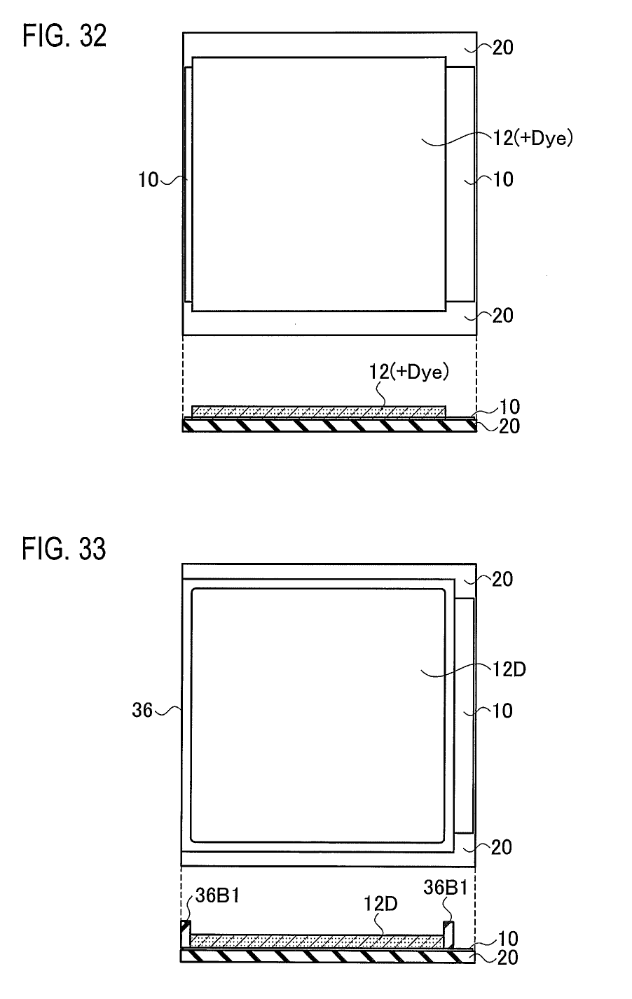

(a) First, as shown in FIG. 30, a transparent electrode 10 is formed on a first substrate 20 composed of a glass substrate or a flexible plastic substrate. The transparent electrode 10 is formed of, FTO, ZnO, ITO, SnO₂, etc., for example, using sputter deposition.
(b) Next, as shown in FIG. 31, a porous semiconductor layer 12 is formed on the transparent electrode 10. More specifically, the porous semiconductor layer 12 is formed by coating a paste containing particulates, e.g. TiO₂, ZnO, WO₃, InO₃, ZrO₂, Ta₂O₃, Nb₂O₃, or SnO₂, for example, using screen printing, and then the paste layer is annealed at a predetermined temperature.
(c) Next, as shown in FIG. 32, the dye is adsorbed on the porous semiconductor layer 12 by impregnating the porous semiconductor layer 12 with a dye solution. Indoline, a red die (N719), and D131 shown in FIG. 8, a black die (N749), etc. are applicable as dyes. Accordingly, as shown in FIG. 32, a working electrode provided with the porous semiconductor layer 12 to which the dye is adsorbed thereto is created.
(d) Next, as shown in FIG. 33, a paste containing a glass frit is coated to surround the porous semiconductor layer 12, thereby forming a first base part 36B1.

More specifically, as shown in FIG. 18, the paste containing the glass frit is coated with screen printing, etc. on the first substrate 20 as the first base part 36B1.

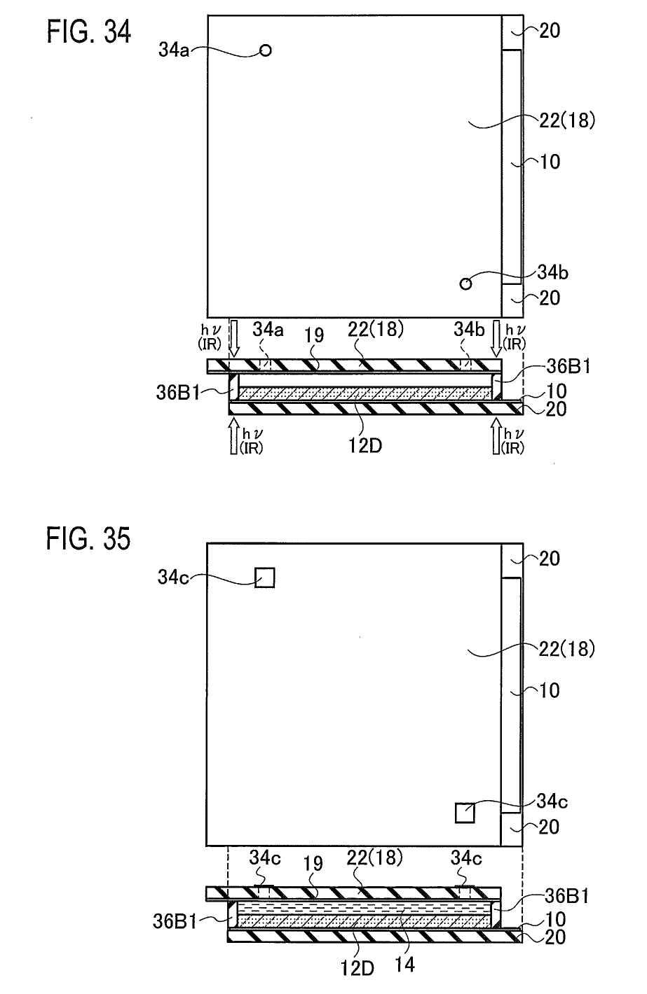

(e) Next, the first base part 36B1 is annealed on predetermined conditions. Accordingly, the first base part 36B1 is formed as a burning body of a paste containing the glass frit.
(f) Next, as shown in FIG. 34, the first substrate 20 and the second substrate 22 are mutually opposed via the first base part 36B1. Note that a second electrode 18 is beforehand formed on the second substrate 22. Moreover, an inlet 34a and an air vent hole 34b for the electrolysis solution 14 are drilled in the second substrate 22. After bonding the first substrate 20 and the second substrate 22 to each other, the first base part 36B1 is in a state shown in FIG. 19C. Then, the first base part 36B1 is irradiated with infrared laser (for example, wavelength of 1064 nm) from any one of the first substrate 20 side or the second substrate 22 side.

Accordingly, the first base part 36B1 absorbs infrared laser, and locally heated to be melted, and thereby the contact part between the first base part 36B1 and the second substrate 22 is fusion bonded.

(g) Next, as shown in FIG. 35, after injecting the electrolysis solution 14 from the inlet 34a, the inlet 34a and the air vent hole 34b are respectively sealed by bonding a glass plate 34c thereto.

The DSCs 200 completed with the above-mentioned process have high sealing nature since the first base part 36B1 composing the sealed part is strongly fusion bonded. Moreover, since the burning body of the paste containing the glass frit has the moisture resistance etc., moisture or oxygen ingress into the cells is effectively prevented, thereby improving weatherability and durability.

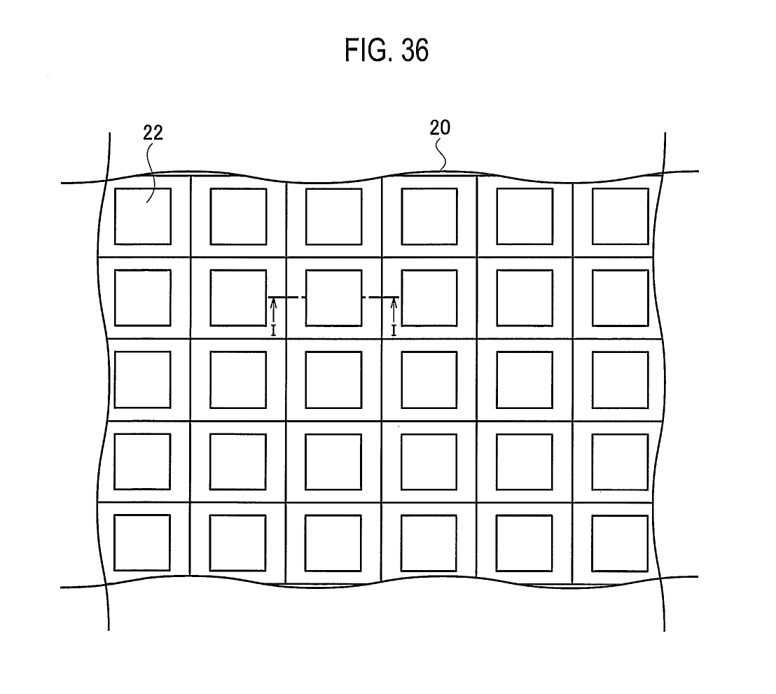

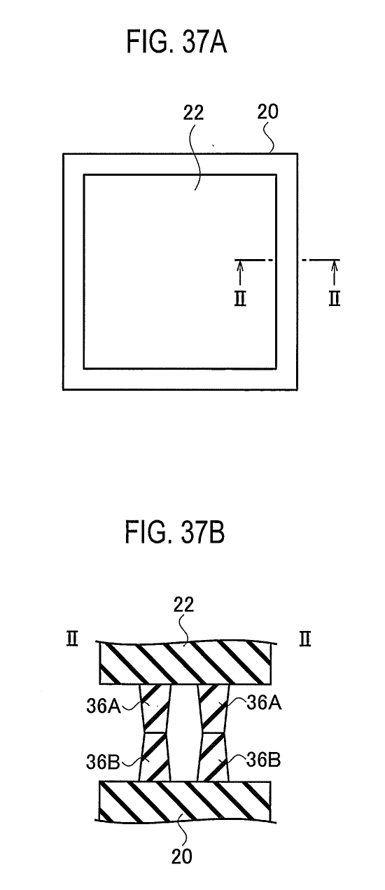

FIG. 36 is a top view diagram showing a case where a plurality of the DSCs are formed, FIG. 37A is a top view diagram showing a structural example of the DSCs, and FIG. 37B is a cross-sectional diagram taken in the line II-II. In an example shown in FIG. 37, the sealed part 36 is formed doubly. In this case, each width of the sealed parts 36 formed doubly is approximately 0.2 mm, for example, and a space between the sealed parts 36 is approximately 0.2 mm, for example.

Thus, the plurality of the DSCs which can improve the weatherability and durability can be efficiently mass-produced in accordance with the method of forming the sealed part doubly by fusion bonding the burning body of the paste containing the glass frit, as mentioned above.

The fusion bonding the first base part 36B and the second base part 36A composed of the burning body of the paste containing the glass frit as shown in FIG. 37B is achieved by irradiating the base parts with the infrared laser (for example, wavelength of 1064 nm) from any one of the first substrate 20 side or the second substrate 22 side, for example.

More specifically, The irradiation with the infrared laser is performed so as to trace a part of the rectangular shape in which the first base part 36B and the second base part 36A are formed (i.e., the irradiation is performed so as to circle around the rectangular).

Accordingly, the first base part 36B and the second base part 36A can be efficiently fusion bonded to each other.

When commercially producing, each dye-sensitized solar cell is separated along with ascribe line, from the state where each DSCs is created, as shown in FIG. 36.

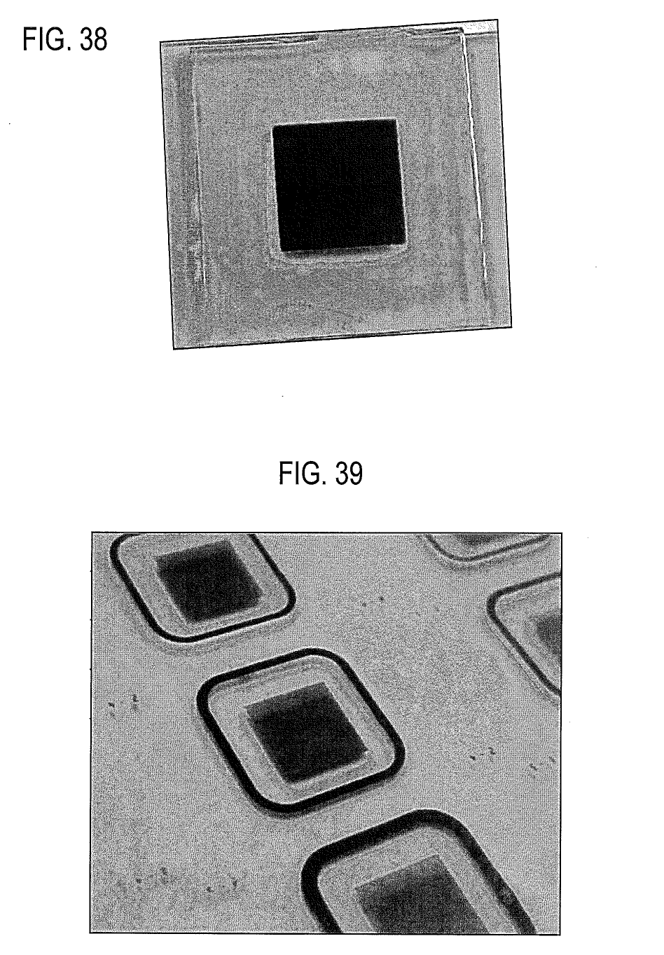

FIG. 38 is a photographic diagram showing an example of production of the DSCs, and FIG. 39 is a photographic diagram showing another example of production of the DSCs. The cell size is approximately 5 mm×5 mm, for example.

### Second Embodiment

Hereinafter, a second embodiment will be described focusing on a different point from the first embodiment.

### (Dye-Sensitized Solar Cells)

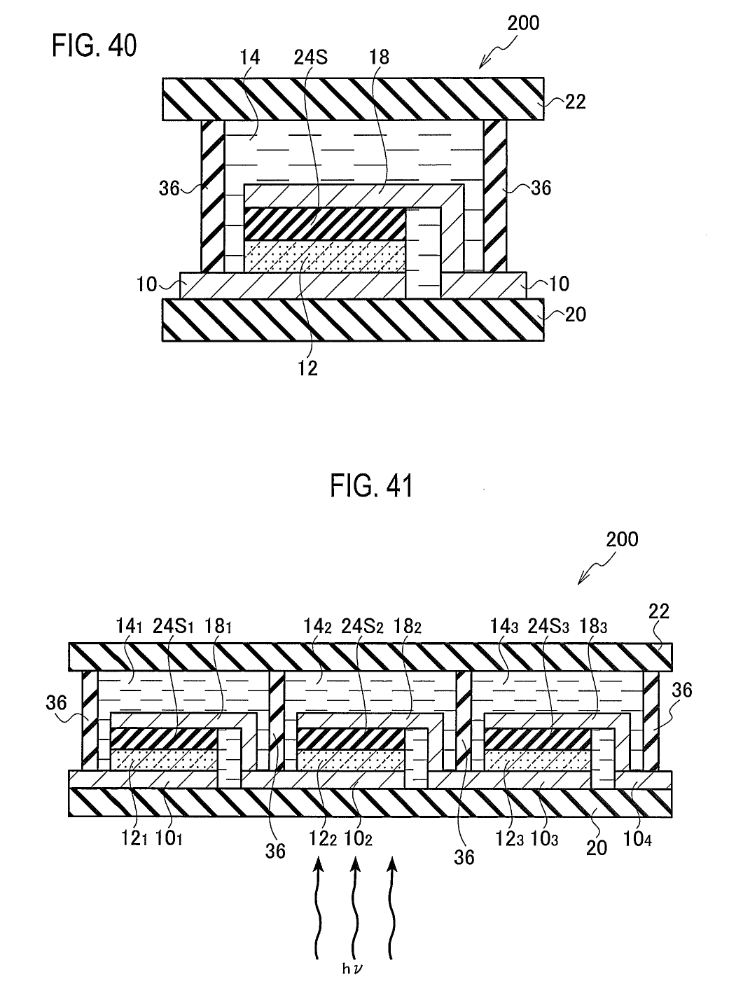

The integrated structure of DSCs 200 according to the second embodiment is monolithic structure as shown in FIG. 40. The monolithic structure is a structure which uses only one expensive glass substrate with a transparent electrode. The structure is structure in which each layer, e.g. a titanium oxide (TiO₂), is directly formed on a lower layer one after another, and then each cell is connected in series finally.

More specifically, the DSCs 200 according to the second embodiment includes: a first substrate 20; a first electrode 10 disposed on the first substrate 20; a porous semiconductor layer 12 disposed on the first electrode 10 and including semiconductor fine particles and dye molecules; an electrolysis solution 14 contacted with the porous semiconductor layer 12 and dissolving a redox electrolyte in a solvent; a second electrode 18 contacted with the electrolysis solution 14; a second substrates 22 disposed on the second electrode 18; and a sealed part 36 for sealing the electrolysis solution 14, the sealed part 36 disposed between the second substrate 20 and the first substrate 22. The sealed part 36 is configured to which a burning body of a paste containing a glass frit is fusion bonded, in the same manner as the first embodiment. The second electrode 18 is a platinum (Pt)), for example, and is also a catalyst layer 19.

In this case, a separator 24S having a predetermined height (for example, approximately 4 μm) may be disposed between the porous semiconductor layer 12 and the second electrode 18. The thickness of the porous semiconductor layer 12 is approximately 8 μm, and the distance between the first electrode 10 and the second electrode 18 is approximately 15-20 μm. A gap may be inserted between the separator 24S and the second electrode 18. Since such a separator 24S is provided, the porous semiconductor layer 12 and the second electrode 18 are securely separated, thereby preventing from the porous semiconductor layer 12 and the second electrode 18 being contacted with each other.

Moreover, the porous semiconductor layer 12 and the separator 24S have the same kind of particulates (for example, TiO₂ etc.) from which the particle diameters mutually differ. The particle diameter of the particulates with which the porous semiconductor layer 12 is provided is approximately 200 nm, and is relatively smaller than the particle diameter of the particulates with which the separator 24S is provided. Therefore, the volume of the dye adsorbed to the particulates with which the porous semiconductor layer 12 is provided is relatively lager than that of the particulates with which the separator 24S is provided.

### (Examples of Serial Arrangement)

A schematic cross-sectional structure in which the DSCs 200 shown in FIG. 40 connected in series is illustrated as shown in FIG. 41. As shown in FIG. 41, the DSCs 200 has a structure of building three cells between the first substrate 20 and the second substrate 22. Three cells are partitioned with the sealed part 36, and each cell is electrically connected. More specifically, the second electrode 18₁ and the first electrode 10₂ are mutually connected, the second electrode 18₂ and the first electrode 10₃ are mutually connected, and the second electrode 18₃ and the first electrode 10₄ are mutually connected. According to such monolithic structure, since it can be composed of only one glass substrate with transparent electrode, it is possible to reduce costs compared with the structure which needs two glass substrates with transparent electrode.

### (Fabrication Method)

Hereinafter, a fabrication method of the DSCs 200 shown in FIG. 41 will be explained.

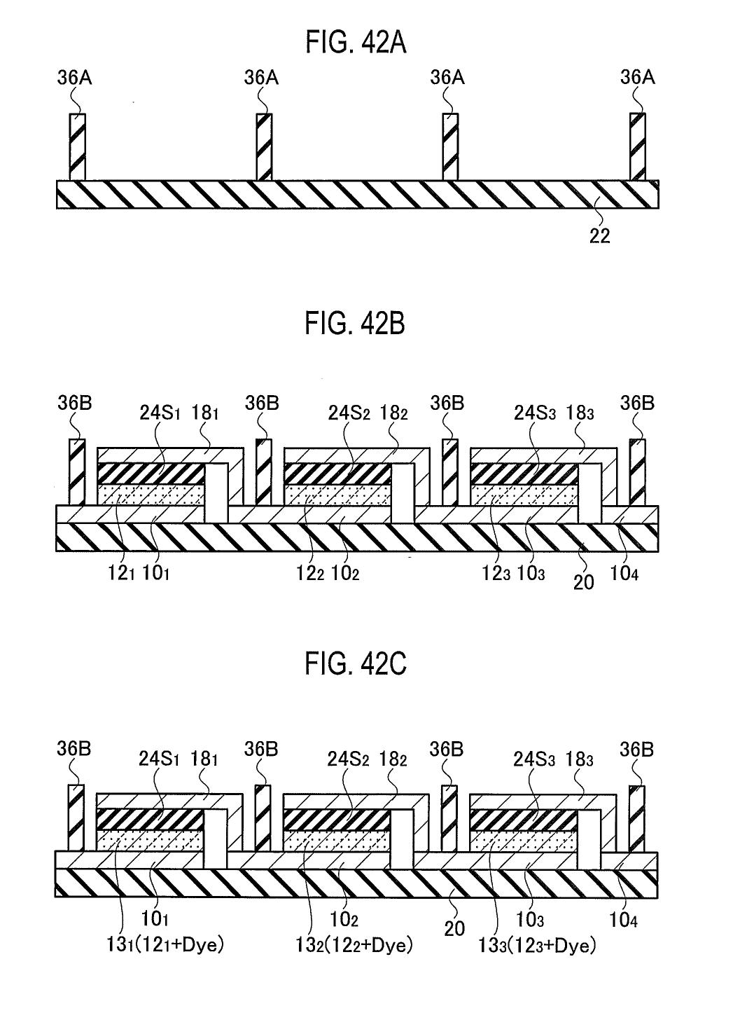

First, as shown in FIG. 42A, a second base part 36A is formed on a second substrate 22. Moreover, as shown in FIG. 42B, first electrodes 10₁, 10₂, 10₃ are formed on a first substrate 20, porous semiconductor layers 12₁, 12₂, 12₃ are formed thereon, separators 24S₁, 24S₂, 24S₃ are formed thereon, and second electrodes 18₁, 18₂, 18₃ are formed thereon. Furthermore, a first base part 36B is formed on the first electrodes 10₁, 10₂, 10₃.

Subsequently, as shown in FIG. 42C, a dye is adsorbed to the porous semiconductor layers 12₁, 12₂, 12₃ after the process shown in FIG. 42B. Hereinafter, the porous semiconductor layer 12 after making the dye is adsorbed thereto may be called a porous semiconductor layer 13.

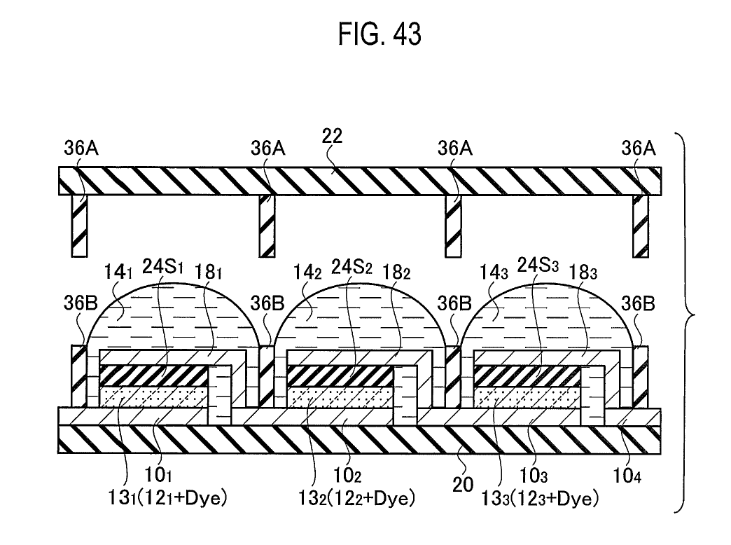

Subsequently, as shown in FIG. 43, it changes into a state where the second base part 36A after the process shown in FIG. 42A and the first base part 36B after the process shown in FIG. 42C are opposed to each other. The electrolysis solution 14 is dropped between the first substrate 20 and the second substrate 22 (described later).

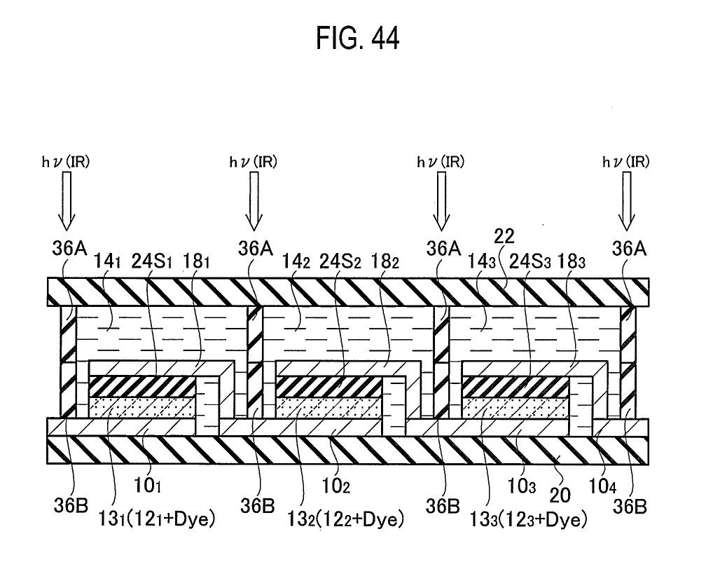

Finally, as shown in FIG. 44, in a state where the first base part 36B and the second base part 36A after the process shown in FIG. 43 are contacted to each other, the contact part therebetween is irradiated with infrared laser (hν (IR)). Accordingly, the first base part 36B and the second base part 36A composed of the burning body of the paste containing the glass frit are locally heated to be melted, thereby sealing the electrolysis solutions 14₁, 14₂, 14₃.

### (Details of Sealing Process of Electrolysis Solution)

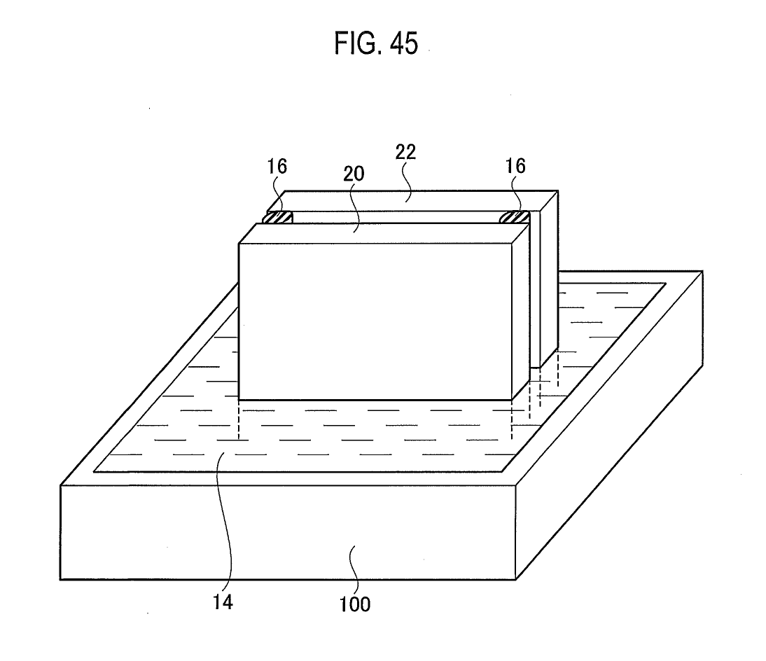

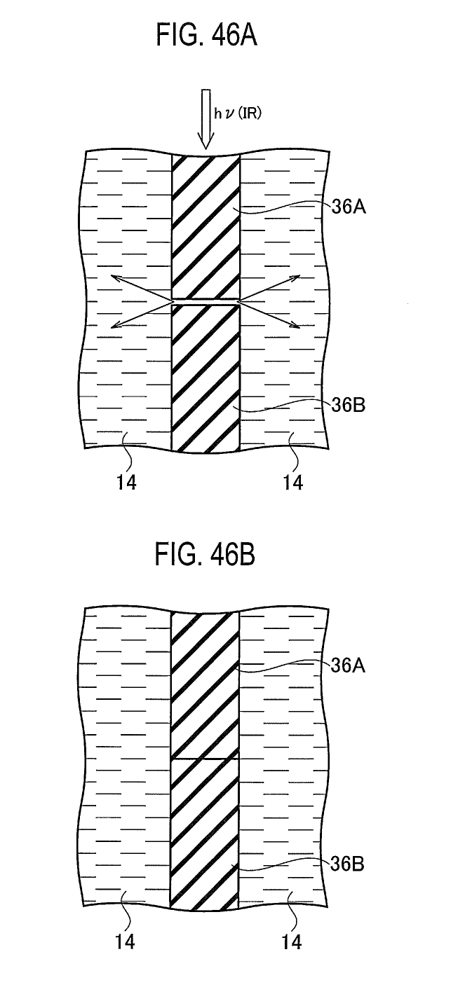

Hereinafter, a process of sealing the electrolysis solution 14 will be explained in more detail, with reference to FIGS. 45 and 46.

First, as shown in FIG. 45, the first substrate 20 and the second substrate 22 are opposed to each other, and then are immersed in a tank 100 of the electrolysis solution 14 in a state of temporary fixing of four corners thereof with the bonding part 16, e.g. a UV curing resin. Subsequently, a vacuum pump (not shown) is operated to decompress to pressure lower than the atmospheric pressure, and then the electrolysis solution 14 ascends between the first substrate 20 and the second substrate 22 in accordance with the capillary phenomenon. Here, when returning to the atmospheric pressure, the electrolysis solution 14 is exposed to the atmospheric pressure, in a state of a pressure reduced state between the first substrate 20 and the second substrate 22 is kept. The electrolysis solution 14 is pushed from the atmospheric pressure due to the pressure difference, and thereby a dye is adsorbed to the porous semiconductor layer 12.

Subsequently, as shown in FIG. 46A, the contact part between the first base part 36B and the second base part 36A is irradiated with the infrared laser (hν (IR)). Accordingly, the first base part 36B and the second base part 36A composed of the burning body of the paste containing the glass frit are locally heated to be melted, and thereby the electrolysis solution 14 escapes out of the contact part due to the heat. Therefore, as shown in FIG. 46B, the first base part 36B and the second base part 36A are fusion bonded to each other in a state where there is no electrolysis solution 14 at the contact part, thereby forming the sealed part 36 with high adhesive strength.

Pressure is applied on the contact part between the first base part 36B and the second base part 36A when irradiating with infrared laser (hν (IR)). Therefore, the height of the first base part 36B and the second base part 36A after fusion bonding is decreased by approximately 30% as compared with the height before fusion bonding.

### (Examples of Module)

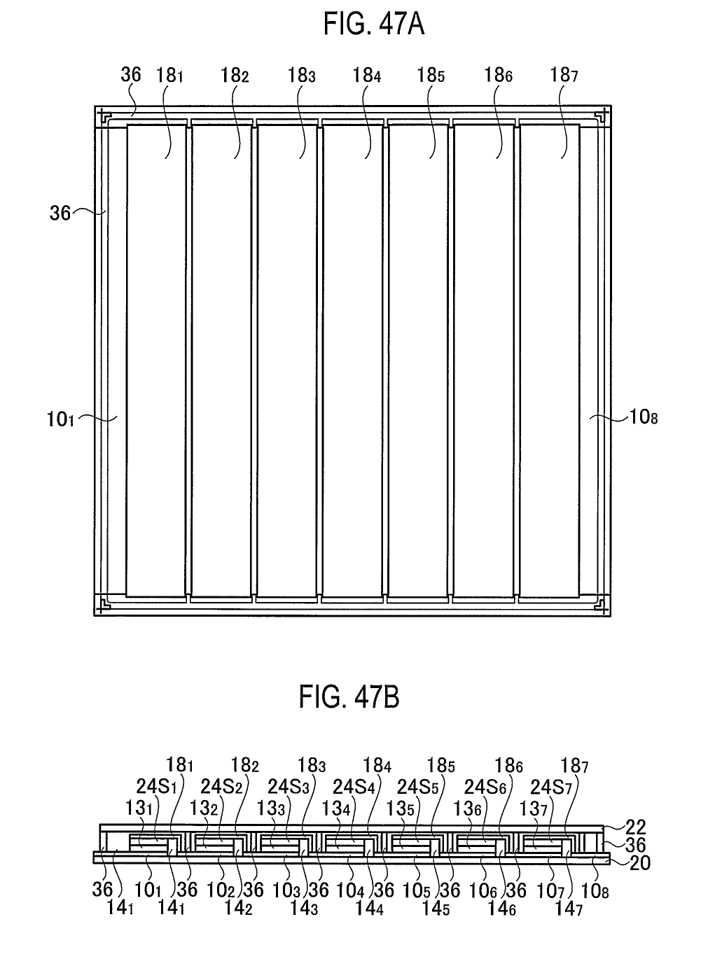

A schematic planar structure of the dye-sensitized solar cell module according to the second embodiment is illustrated as shown in FIG. 47A, and a schematic cross-sectional structure thereof is illustrated as shown in FIG. 47B. As shown in FIG. 47A, reed-shaped seven cells are connected in series between the first substrate 20 and the second substrate 22. Moreover, as shown in FIG. 47B, the seven cells are partitioned with the sealed part 36, and the electrolysis solutions 14₁, 14₂, 14₃, 14₄, 14₅, 14₆, 14₇ are sealed in the cells. Other fundamental structures are the same as having explained with reference to FIG. 41.

As mentioned above, the sealed part 36 is configured to which the burning body of the paste containing the glass frit is fusion bonded, also in the second embodiment. Accordingly, in the relatively low-cost DSCs 200 having monolithic structure, it is possible to form the sealed part 36 with high adhesive strength in the same manner as the first embodiment.

### Third Embodiment

Generally, although the structure in which an incident light is absorbed via transparent electrode, e.g. ITO or FTO, is adopted in DSCs, such a transparent electrode has large optical loss. Accordingly, the object of the third embodiment is to provide DSCs which can reduce optical loss, and provide a fabrication method of such DSCs. Hereinafter, since the third embodiment is explained focusing on different points from the first or second embodiment, and detailed descriptions are omitted regarding the same structure.

### (Dye-Sensitized Solar Cells)

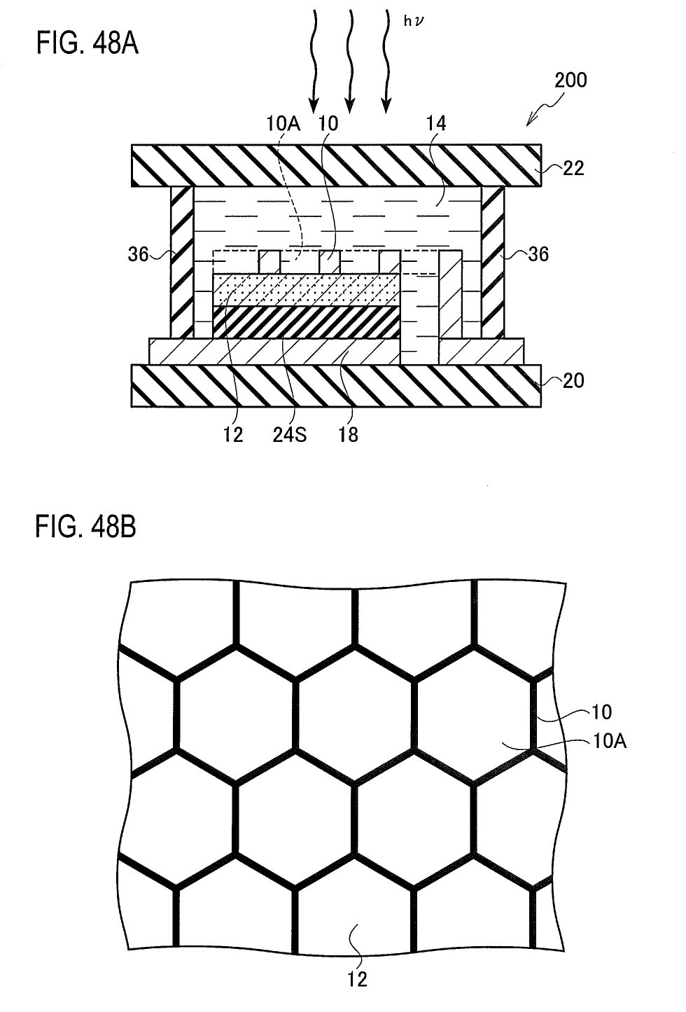

An integrated structure of the DSCs 200 according to the third embodiment is illustrated as shown in FIG. 48. As shown in FIG. 48A, a first electrode 10 is a metal electrode having an aperture 10A, and a second electrode 18, a separator 24S, a porous semiconductor layer 12, and a first electrode 10 are disposed in order of the second electrode 18, the separator 24S, the porous semiconductor layer 12, and the first electrode 10 from a first substrate 20 side. Moreover, as shown in FIG. 48B, the metal electrode having the aperture 10A may be a mesh electrode having honeycomb structure.

Accordingly, the physical relationship of the power generation unit is opposite to that of the second embodiment, and therefore an incident light can be absorbed through the aperture 10A of the first electrode 10 from the second substrate 22 side. In other words, the DSCs 200 according to the third embodiment have an inverted structure type monolithic structure which can absorb the incident light without via the transparent electrode having large optical loss.

More specifically, the DSCs 200 according to the third embodiment includes: a first substrate 20; a second electrode 18 disposed on the first substrate 20; a separator 24S having a predetermined height disposed on the second electrode 18; a porous semiconductor layer 12 disposed on the separator 24S and including semiconductor particulates and dye molecules; a first electrode 10 which is a metal electrode having an aperture 10A disposed on the porous semiconductor layer 12; an electrolysis solution 14 contacted with the porous semiconductor layer 12 and dissolving a redox electrolyte in a solvent; a second substrate 22 disposed so as to leave a predetermined gap above the first electrode 10; and a sealed part 36 for sealing the electrolysis solution 14, the sealed part 36 disposed between the second substrate 20 and the first substrate 22. In the third embodiment, the structure of the sealed part 36 is not limited, and therefore various structures can be adopted (describes later).

### (Examples of Mesh Electrode)

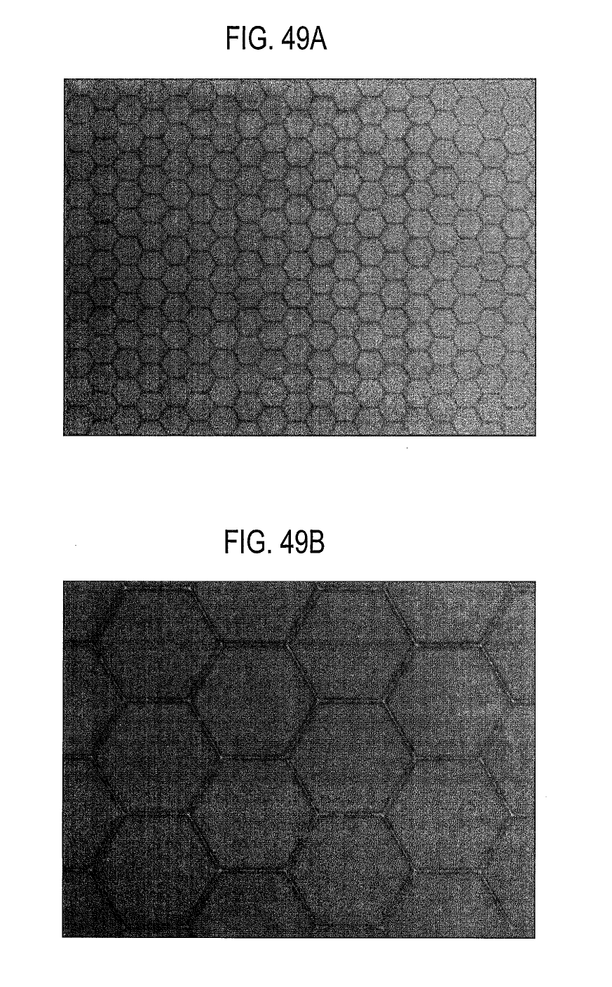

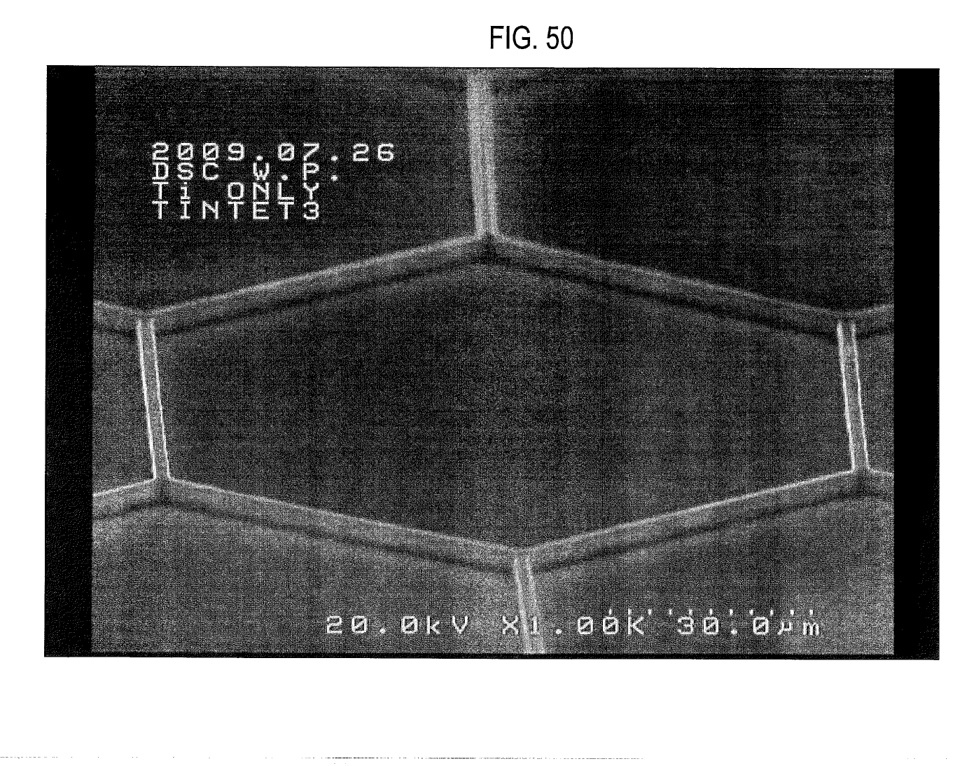

It is an example of the first electrode 10 shown in FIG. 48, an example of optical microscope photograph of the first electrode 10 is illustrated as shown in FIG. 49A, and an example of optical microscope photograph to which a part of the photograph shown in FIG. 49A is expanded is illustrated as shown in FIG. 49B. Moreover, an example of an SEM photograph of the first electrode 10 shown in FIG. 48 is illustrated as shown in FIG. 50. As shown in FIGS. 49 and 50, the first electrode 10 is a mesh electrode having honeycomb structure. Ti etc. can be used as materials of the mesh electrode. The line width of the mesh electrode is approximately 3 μm, the thickness of the mesh electrode is approximately 2 μm, and the distance (pitch) between the adjacent honeycombs is approximately 50 μm. In this case, the whole energy spectrum line transmittance is approximately 88%, and a value of the resistance is approximately 6-8Ω/□, for example.

On the other hand, in the case of the first electrode 10 is formed of ITO, a value of the resistance are approximately 10Ω/□, for example, but if TiO₂ is annealed at approximately 500 degrees C., ITO will deteriorate, the value of the resistance will rise to approximately 50-100Ω/□, for example. According to the present embodiment, since the first electrode 10 is formed of Ti, even if the annealing is performed, the value of the resistance does not change.

### (Modified Examples of Mesh Electrode)

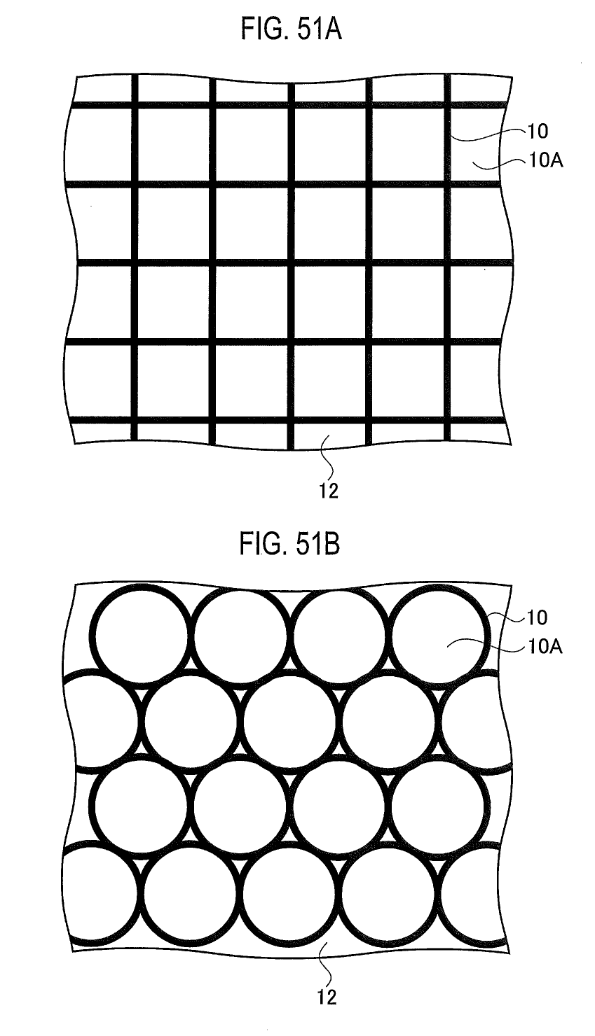

A schematic planar structure showing a modified example of the first electrode 10 shown in FIG. 48 is illustrated as shown in FIG. 51. As shown in FIG. 51A, the shape of the aperture 10A in the first electrode 10 may be quadrangle. Alternatively, as shown in FIG. 51B, the shape of the aperture 10A in the first electrode 10 may be circular. Naturally, it is also possible to adopt shapes except quadrangle and circular.

### (Examples of Serial Arrangement)

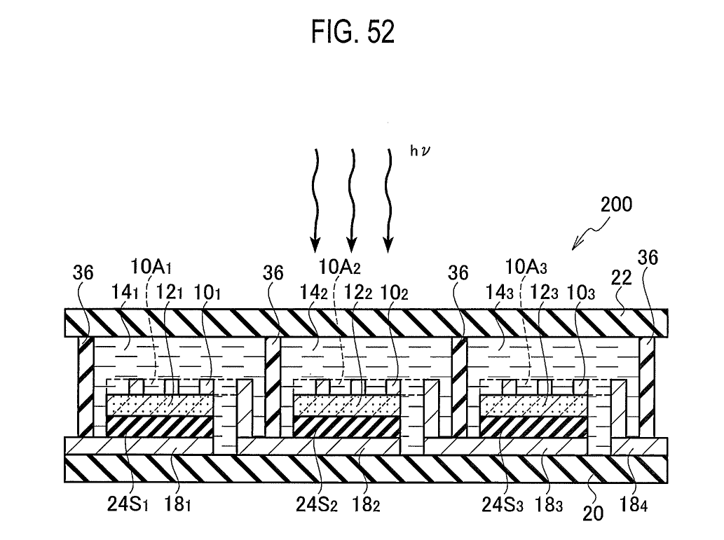

A schematic cross-sectional structure in which the DSCs 200 shown in FIG. 48 connected in series is illustrated as shown in FIG. 52. As shown in FIG. 52, the DSCs 200 has a structure of building three cells between the first substrate 20 and the second substrate 22. Three cells are partitioned with the sealed part 36, and each cell is electrically connected. More specifically, the first electrode 10₁ and the second electrode 18₂ are mutually connected, the first electrode 10₂ and the second electrode 18₃ are mutually connected, and the first electrode 10₃ and the second electrode 18₄ are mutually connected. The DSCs 200 have structure of producing electric power, receiving photons (hν) through the aperture 10A of the first electrode 10 from the second substrate 22 side.

### (Fabrication Method)

A fabrication method of the DSCs 200 according to the third embodiment includes: forming a first substrate 20; forming a second substrate 22; forming a second electrode 18 on the first substrate 20; forming a separator 24S having a predetermined height on the second electrode 18; forming a porous semiconductor layer 12 including semiconductor particulates on the separator 24S; impregnating the porous semiconductor layer 12 with a dye solution to adsorb dye molecules; forming a first electrode 10 which is a metal electrode having an aperture 10A on the porous semiconductor layer 12; and sealing an electrolysis solution 14 in which a redox electrolyte is dissolved in a solvent with a sealed part 36 disposed between the first substrate 20 and the second substrate 22.

Hereinafter, the fabrication method of the DSCs 200 shown in FIG. 52 will be specifically explained.

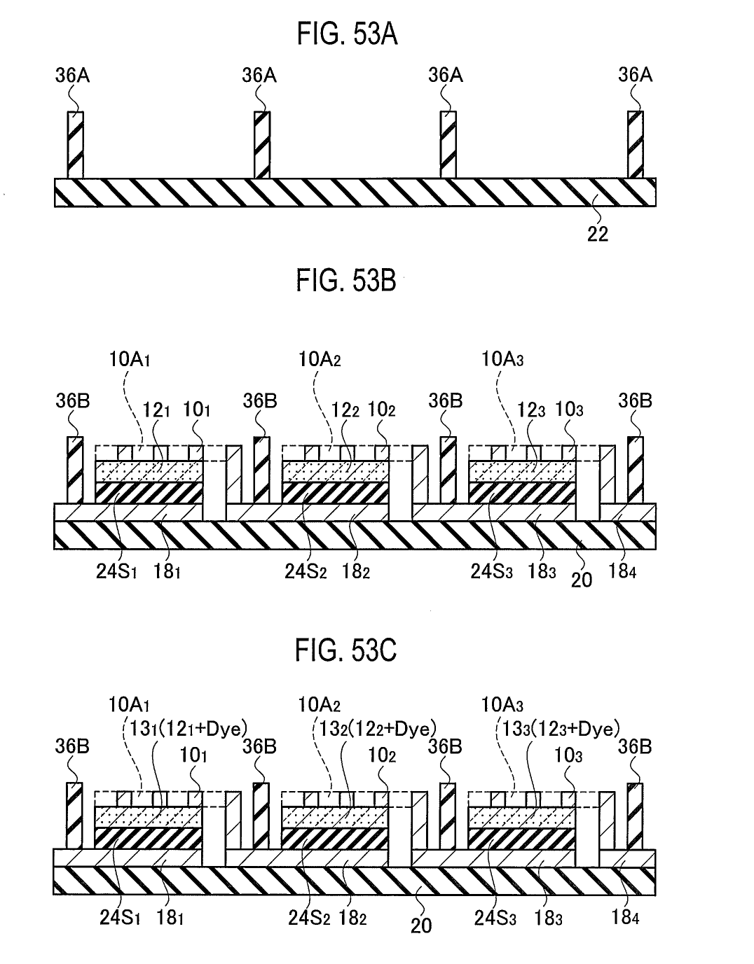

First, as shown in FIG. 53A, a second base part 36A is formed on a second substrate 22. Moreover, as shown in FIG. 53B, second electrodes 18₁, 18₂, 18₃ are formed on a first substrate 20, separators 24S₁, 24S₂, 24S₃ are formed thereon, porous semiconductor layers 12₁, 12₂, 12₃ are formed thereon, and first electrodes 10₁, 10₂, 10₃ are formed thereon. The first electrodes 10₁, 10₂, 10₃ are mesh electrodes having honeycomb structure. For example, the mesh electrode having honeycomb structure can be formed by forming a titanium film by a sputtering technique and then performing sensitization/exposure and etching. Furthermore, a first base part 36B is formed on the second electrodes 18₁, 18₂, 18₃.

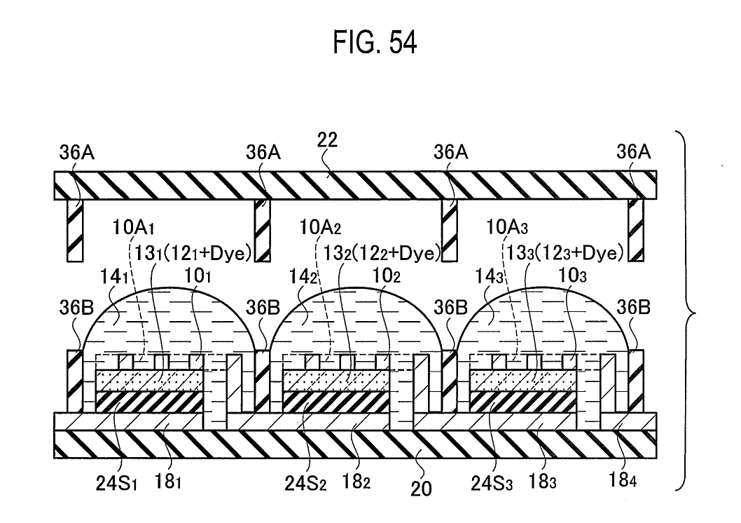

Subsequently, as shown in FIG. 53C, a dye is adsorbed to the porous semiconductor layers 12₁, 12₂, 12₃ after the process shown in FIG. 53B. Furthermore, as shown in FIG. 54, it changes into a state where the second base part 36A after the process shown in FIG. 53A and the first base part 36B after the process shown in FIG. 53C are opposed to each other. The electrolysis solution 14 is dropped between the first substrate 20 and the second substrate 22 later.

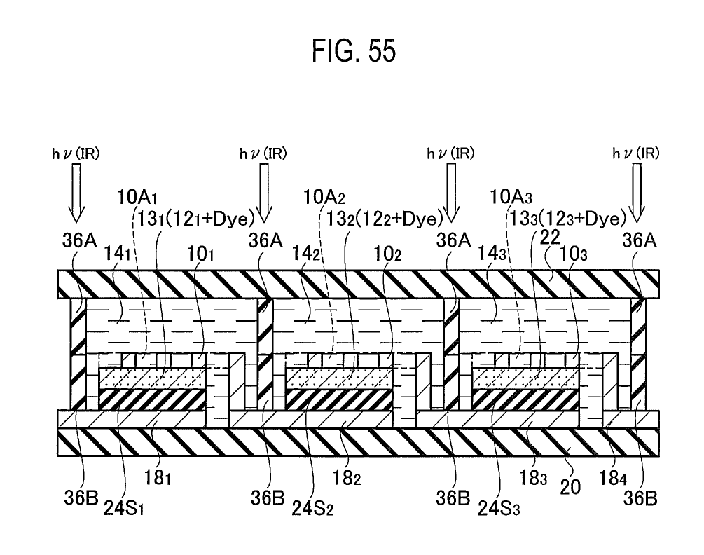

Finally, as shown in FIG. 55, in a state where the first base part 36B and the second base part 36A after the process shown in FIG. 54 are contacted to each other, the contact part therebetween is irradiated with infrared laser (hν (IR)). Accordingly, the first base part 36B and the second base part 36A composed of the burning body of the paste containing the glass frit are locally heated to be melted, thereby sealing the electrolysis solutions 14₁, 14₂, 14₃.

As mentioned above, according to the third embodiment, the incident light can be absorbed through the aperture 10A of the first electrode 10 from the second substrate 22 side. Accordingly, it is possible to improve generation efficiency, since optical loss is reduced compared with the case where an incident light is absorbed via a transparent electrode. Moreover, various substances, e.g. a metal film in which light does not pass through can be used for the second electrode 18, since the second electrode 18 do not need to be formed with a transparent electrode. Furthermore, there is a merit that the value of the resistance does not change even if annealing is performed since the first electrode 10 is formed of Ti etc.

### (Sealed Part in Third Embodiment)

In the third embodiment, the structure of the sealed part 36 is not limited, and therefore various structures can be adopted later. That is, the sealed part 36 may be composed so that a burning body of a paste containing a glass frit is fusion bonded, in the same manner as the first or second embodiment. Alternatively, the sealed part 36 may be composed using photo-curing resin, e.g. an ultraviolet curing resin (UV curing resin). More specifically, it is possible to suitably select one of the sealed parts 36 explained hereinafter.

### Comparative Example

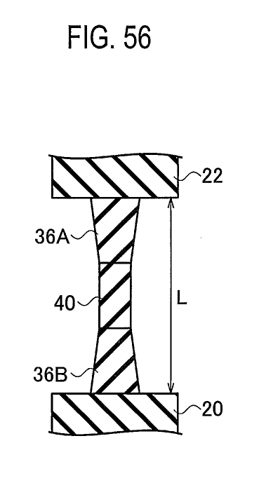

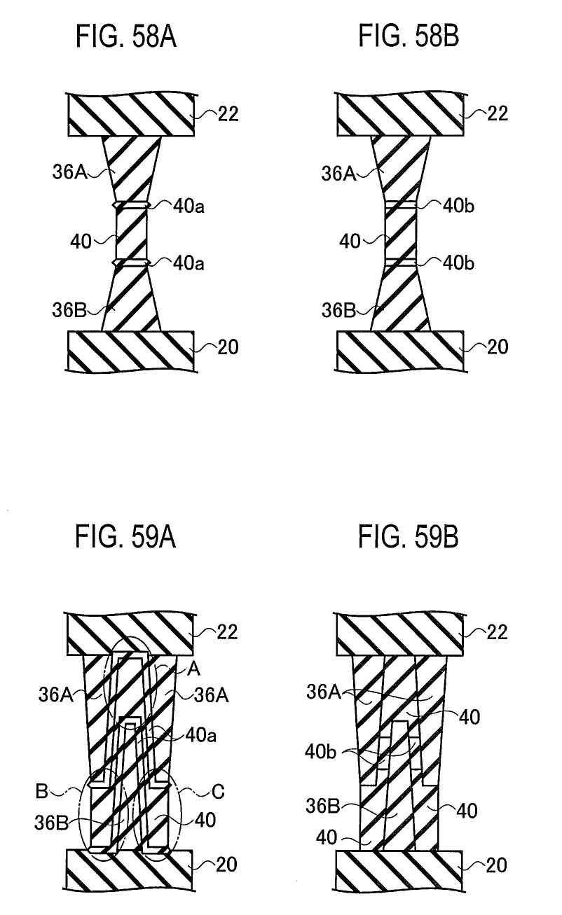

First, a structure of the sealed part 36 as a comparative example will be explained, with reference to FIGS. 56 and 58.

The sealed part 36 is composed of a first base part 36B and a second base part 36A using a photo-curing resin having a predetermined height (for example, about 10 μm) each beforehand formed on the first substrate 20 side and the second substrate 22 side; and a bonding part 40 composed of an ultraviolet curing resin inserted between the first base part 36B and the second base part 36A.

The thickness L of the whole sealed part 36 is approximately 30 μm, for example. That is, in an example shown in FIG. 56, each height of the first base part 36B, the second base part 36A, and the bonding part 40 is approximately 10 μm.

Although the first base part 36B, the second base part 36A, and the bonding part 40 are formed by coating an ultraviolet curing resin using screen printing, the thickness formed at one process of the printing method is right approximately 10 μm.

In this case, the ultraviolet curing resin which composes the bonding part 40 is coated on a tip part of the first base part 36B or the second base part 36A formed beforehand. Then, the first substrate 20 and the second substrate 22 are mutually opposed, and between the first base part 36B and the second base part 36A is bonded via the bonding part 40 composed of the ultraviolet curing resin (refer to FIG. 58A). In FIG. 58A, the reference numeral 40a denotes contact parts between the bonding part 40 and the first base part 36B, and between the bonding part 40 and the second base part 36A.

Subsequently, the ultraviolet rays (UV) is irradiated from the first substrate 20 side or the second substrate 22 side, and cures the ultraviolet curing resin which composes the bonding part 40 (refer to FIG. 58B). In FIG. 58B, the reference numeral 40b denotes contact parts between the bonding part 40 and the first base part 36B, and between the bonding part 40 and the second base part 36A.

However, according to the sealed part 36 in the comparative example, since the first base part 36B and the second base part 36A are formed of the ultraviolet curing resin, it has characteristics that the sealed part 36 itself tends to absorb the ultraviolet rays.

Therefore, since the ultraviolet rays (UV) is absorbed to some extent until the ultraviolet rays (UV) irradiated from the first substrate 20 side or the second substrate 22 side reach the ultraviolet curing resin composing the bonding part 40, and the ultraviolet curing resin is not fully cured.

Moreover, in the case where curing of the bonding part 40 is insufficient, since a moisture or an oxygen are comparatively easily infiltrated in the cells, and the power generation performance is degraded due to react to the electrolysis solution 14, sufficient durability of the DSCs is not securable.

### Practical Examples

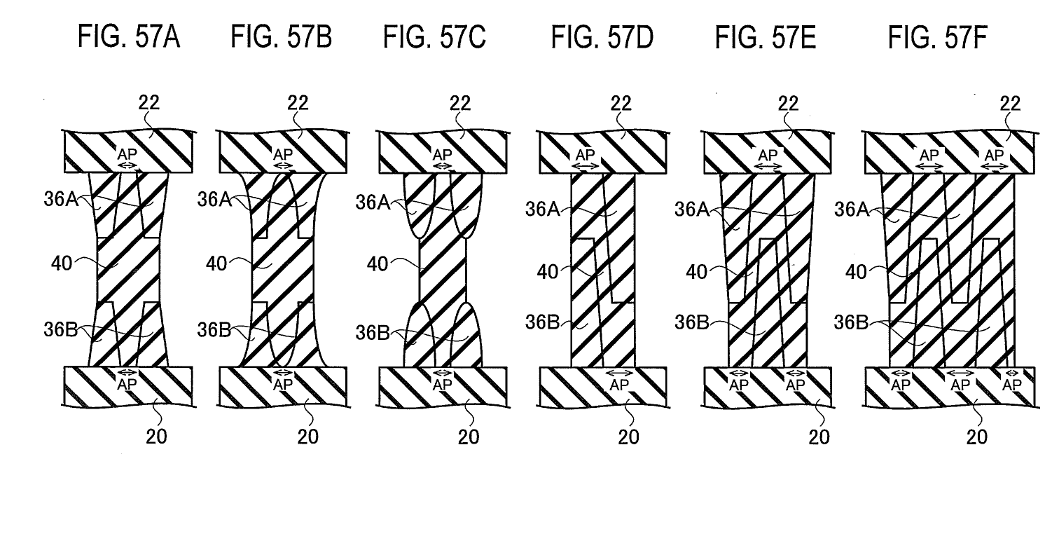

Next, nineteenth to twenty-fourth practical examples will be described, with reference to FIGS. 57A-57F.

The nineteenth to twenty-fourth practical examples shown in FIGS. 57A-57C are structural examples in a case of forming a pair of the first base part 36B of and a pair of the second base part 36A so that tip parts of the first base part 36B of and tip parts of the second base part 36A are mutually opposed at the time when the first substrate 20 and the second substrate 22 are mutually opposed.

In the nineteenth to twenty-fourth practical examples shown in FIGS. 57A-57C, apertures AP in which the ultraviolet rays (UV) for curing the ultraviolet curing resin are entered to the bonding part 40 are formed in the first base part 36B side and the second base part 36A side.

The width of the aperture AP may be approximately 0.05-0.5 mm, for example.

In the nineteenth practical example shown in FIG. 57A, the first base part 36B and the second base part 36A are formed so that the sectional shape thereof has approximately wedge shape.

In the twentieth practical example shown in FIG. 57B and the twenty-first practical example shown in FIG. 57C, the first base part 36B and the second base part 36A have a shape to which the cross-sectional area becomes smaller as being away from the first substrate 20 and the second substrate 22.

In the twentieth practical example shown in FIG. 57B, the first base part 36B and the second base part 36A has a shape in which each side portion has a negative curvature.

Moreover, in the twenty-first practical example shown in FIG. 57C, the first base part 36B and the second base part 36A has a shape in which each side portion has a positive curvature.

In the nineteenth to twenty-fourth practical examples shown in FIGS. 57A-57C, the ultraviolet rays (UV) can be entered in the ultraviolet curing resin composing the bonding part 40 from the apertures AP in at least one side of the first base part 36B and the second base part 36A, thereby curing the ultraviolet curing resin.

In this case, since the ultraviolet rays (UV) is directly entered to the ultraviolet curing resin composing the bonding part 40 via the apertures AP, the quantity of light for fully curing the ultraviolet curing resin is further securable, compared with the above-mentioned comparative example. Accordingly, the whole bonding part 40 also including the central part is fully cured, thereby securely bonding between the first base part 36B and the second base part 36A.

Moreover, since the contact area between the bonding part 40 and the first base part 36B and between the bonding part 40 and the second base part 36A is larger than that of the comparative example, the bonding strength can be increased.

Accordingly, moisture or oxygen ingress into the cells is effectively prevented, thereby improving the durability of the DSCs 200.

Note that three or more first base parts 36B and three or more second base parts 36A may be formed, and the apertures AP may be formed respectively between the first base parts and between the second base parts.

The twenty-second to twenty-fourth practical examples shown in FIGS. 57D-57F are structural examples in a case of forming the first base part 36B and the second base part 36A so that a position of the tip part of the first base part 36B and the tip part of the second base part 36A are in a staggered configuration at the time when the first substrate 20 and the second substrate 22 are mutually opposed.

In the twenty-second to twenty-fourth practical examples shown in FIGS. 57D-57F, the first base part 36B and the second base part 36A may be formed at a height so that respective tip parts overlap in a line direction, at the time when the tip part of the first base part 36B and the tip part of the second base part 36A are mutually opposed.

In the twenty-second practical example shown in FIG. 57D, the first one base part 36B and one second base part 36A are respectively formed on the first substrate 20 and the second substrate 22. Moreover, each of the first base part 36B and the second base part 36A are disposed so as to sandwich a gap to which the ultraviolet curing resin composing the bonding part 40 is inserted, at the time when the first substrate 20 and the second substrate 22 are mutually opposed.

FIG. 59 is a diagram showing a process of forming the sealed part according to the twenty-third practical example, FIG. 59A is a cross-sectional diagram showing a state before curing the bonding part 40, and FIG. 59B is a cross-sectional diagram showing a state after curing the bonding part 40.

In FIG. 59A, the reference numeral 40a denotes contact parts between the bonding part 40 and the first base part 36B, and between the bonding part 40 and the second base part 36A. Moreover, areas enclosed with dashed dotted lines A, B, and C correspond to portions cured in particular strongly by the irradiation of the ultraviolet rays (UV).

In FIG. 59B, although but a reference numeral 40b denotes an insufficient hardening portion in which the ultraviolet rays (UV) are not distributed, sufficient intensity is obtained from a practical viewpoint since other portions are fully cured.

In the twenty-third practical example shown in FIG. 57E, one first base part 36B is formed on the first substrate 20, and two second base parts 36A are formed on the second substrate 22. Moreover, the first base part 36B is disposed so as to be positioned between the two second base parts 36A at the time when the first substrate 20 and the second substrate 22 are mutually opposed, and the first base part 36B and the second base part 36A sandwich the ultraviolet curing resin composing the bonding part 40.

In the twenty-fourth practical example shown in FIG. 57F, a pair of the first base parts 36B is formed on the first substrate 20, and a pair of the second base parts 36A are formed on the second substrate 22. Moreover, the first base part 36B and the second base part 36A is disposed so as to be mutually staggered at the time when the first substrate 20 and the second substrate 22 are mutually opposed, each of the pair of the first base part 36B and the pair of the second base part 36A sandwich the ultraviolet curing resin composing the bonding part 40.

In the twenty-second to twenty-fourth practical examples shown in FIGS. 57D-57F, the first base part 36B and the second base part 36A are formed so that the sectional shape thereof has approximately wedge shape.

Moreover, in the twenty-second to twenty-fourth practical examples shown in FIGS. 57D-57F, the ultraviolet rays (UV) can be entered in the ultraviolet curing resin composing the bonding part 40 from the apertures AP in at least one side of the first base part 36B and the second base part 36A, thereby hardening the ultraviolet curing resin.

In this case, since the ultraviolet rays (UV) is directly entered to the ultraviolet curing resin composing the bonding part 40 via the apertures AP, the quantity of light for fully curing the ultraviolet curing resin is further securable, compared with the above-mentioned comparative example. Accordingly, the whole bonding part 40 is fully cured, thereby strongly bonding between the first base part 36B and the second base part 36A.

Moreover, since the contact area between the bonding part 40 and the first base part 36B and between the bonding part 40 and the second base part 36A is larger than that of the comparative example, the bonding strength can be increased. In particular, according to the twenty-fourth practical example shown in FIG. 57E, and the twenty-third practical example shown in FIG. 57F, an anchor effect due to frictional force is produced between the bonding part 40 and the first base part 36B and between the bonding part 40 and the second base part 36A, thereby further strongly bonding between the first base part 36B and the second base part 36A.

Accordingly, moisture or oxygen ingress into the cells is effectively prevented, thereby significantly improving the durability of the DSCs 200.

Note that three or more first base parts 36B on the first substrate 20 and three or more second base parts 36A on the second substrate 22 may be respectively formed in the twenty-fourth practical example.

Moreover, in the twenty-second to twenty-fourth practical examples, the ultraviolet curing resin which forms the first base part 36B and the second base part 36A, and the ultraviolet curing resin which forms the bonding part 40 may be cured with lights of mutually different wavelengths.

That is, for example, it can be use an ultraviolet curing resin cured with ultraviolet rays W1 of wavelength λ1, and an ultraviolet curing resin cured with ultraviolet rays of wavelength λ2.

More specifically, for example, an ultraviolet curing resin cured with ultraviolet rays of 360-nm wavelength can be used for the first base part 36B and the second base part 36A, and an ultraviolet curing resin cured with ultraviolet rays of 380-nm wavelength can be used for the bonding part 40. Accordingly, the bonding part 40 can be further securely cured with the ultraviolet rays of 380-nm wavelength which can be entered to deeper portions.

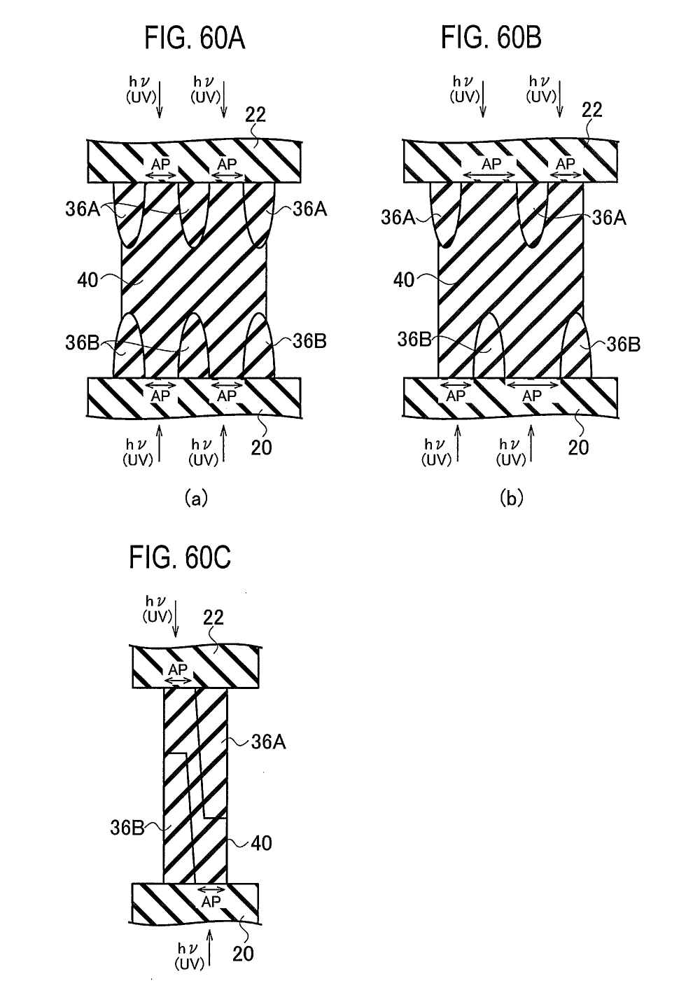

Next, twenty-fifth practical example and twenty-sixth practical example of the present invention will be described, with reference to FIGS. 60A and 60B.

The twenty-fifth practical example shown in FIG. 60A has a structure of adding one first base part 36B and one second base part 36A with respect to the structure of the above-mentioned twenty-first practical example shown in FIG. 57C.

Accordingly the contact areas between the bonding part 40 and the first base part 36B and between the bonding part 40 and the second base part 36A becomes larger, thereby further improving the bonding strength.

Moreover, two apertures AP are provided in the first substrate 20 side, and two apertures AP are also provided in the second substrate 22 side, and the ultraviolet rays (UV) is further certainly entered into the ultraviolet curing resin composing the bonding part 40 via the apertures AP. Accordingly, the bonding part 40 is fully cured, thereby further strongly bonding the bonding part 40 and the first base part 36B, and the bonding part 40 and the second base part 36A.

The twenty-sixth practical example shown in FIG. 60B is an example in which the first base part 36B and the second base part 36A formed as the twenty-first practical example shown in FIG. 57C are applied to the above-mentioned twenty-fourth practical example shown in FIG. 57F. In this case, as shown in FIG. 60B, the first base part 36B and the second base part 36A is overlapped in a line direction. Also in this case, the ultraviolet rays (UV) with sufficient quantity of light are entered into the ultraviolet curing resin composing the bonding part 40 via the apertures AP. Accordingly, the bonding part 40 is fully cured, thereby strongly bonding the bonding part 40 and the first base part 36B, and the bonding part 40 and the second base part 36A.

FIG. 60C is a sectional view showing a state of the sealed part according to the above-mentioned twenty-second practical example. The contact surface between the first base part 36B (or the second base part 36A) and the bonding part 40 has micro-concavoconvex with predetermined surface roughness (for example, the surface roughness Rs=100-1000 μm). This is because the ultraviolet curing resin becomes particulate matter at the time of passing through a meshed-shape screen, when the ultraviolet curing resin composing the first base part 36B, the second base part 36A, and the bonding part 40 is coated with screen printing.

Thus, since the contact surface between the first base part 36B (or the second base part 36A) and the bonding part 40 has micro-concavoconvex, the frictional force in the contact surface increases, thereby further strongly bonding the first base part 36B (or the second base part 36A) and the bonding part 40.

### (Practical Examples of Sealed Part)

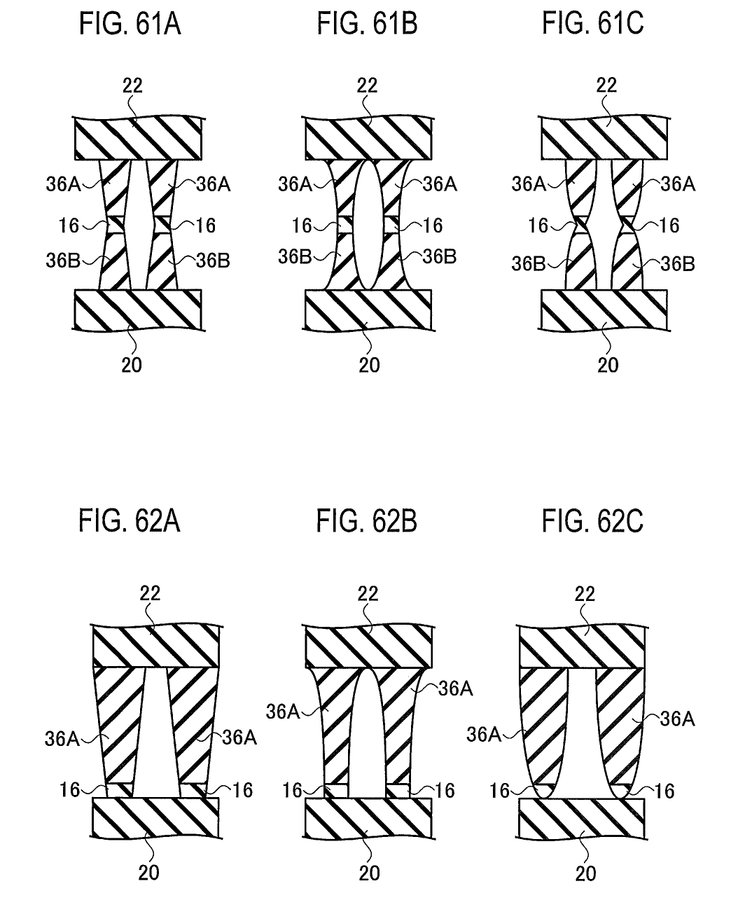

FIG. 61A is a sectional view showing a structural example of the sealed part according to a twenty-seventh practical example. As shown in FIG. 61A, in the present practical example, a sectional shape of the first base part 36B and the second base part 36A each formed in two pieces is a wedge shape.

FIG. 61B is a sectional view showing a structural example of the sealed part according to a twenty-eighth practical example. As shown in FIG. 61B, in the present practical example, a sectional shape of the first base part 36B and the second base part 36A each formed in two pieces is a taper shape to which cross-sectional area becomes smaller as being away from the first substrate 20 and the second substrate 22.

FIG. 61C is a sectional view showing a structural example of the sealed part according to a twenty-ninth practical example. As shown in FIG. 61C, in the present practical example, a sectional shape of the second base part 36A and the first base part 36B each formed in two pieces is a spindle-formed taper shape to which cross-sectional area becomes smaller as being away from the first substrate 20 and the second substrate 22.

FIG. 62A is a sectional view showing a structural example of the sealed part according to a thirty practical example. As shown in FIG. 62A, in the present practical example, a sectional shape of the first base part 36B formed in two pieces is a wedge shape.

FIG. 62B is a sectional view showing a structural example of the sealed part according to a thirty-first practical example. As shown in FIG. 62B, in the present practical example, a sectional shape of the first base part 36B formed in two pieces is a taper shape to which cross-sectional area becomes smaller as being away from the second substrate 22.

FIG. 62C is a sectional view showing a structural example of the sealed part according to a thirty-second practical example. As shown in FIG. 62C, in the present practical example, a sectional shape of the first base part 36B formed in two pieces is a spindle-formed taper shape to which cross-sectional area becomes smaller as being away from the second substrate 22.

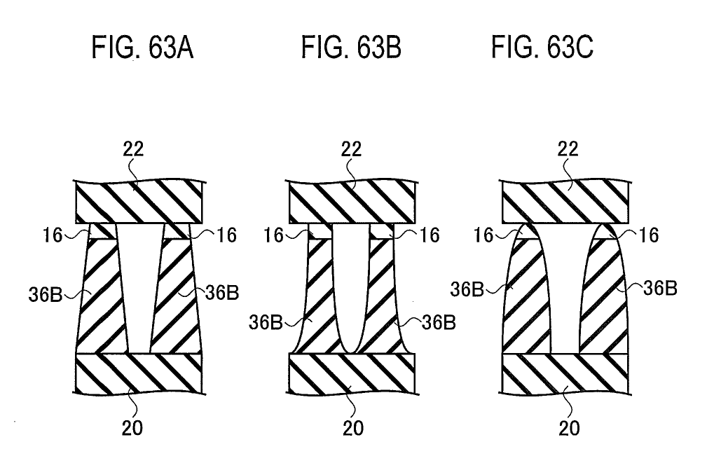

FIG. 63A is a sectional view showing a structural example of the sealed part according to a thirty-third practical example. As shown in FIG. 63A, in the present practical example, a sectional shape of the second base part 36A formed in two pieces is a wedge shape.

FIG. 63B is a sectional view showing a structural example of the sealed part according to a thirty-fourth practical example. As shown in FIG. 63B, in the present practical example, a sectional shape of the second base part 36A formed in two pieces is a taper shape to which cross-sectional area becomes smaller as being away from the first substrate 20.

FIG. 63C is a sectional view showing a structural example of the sealed part according to a thirty-fifth practical example. As shown in FIG. 63C, in the present practical example, a sectional shape of the second base part 36A formed in two pieces is a spindle-formed taper shape to which cross-sectional area becomes smaller as being away from the first substrate 20.

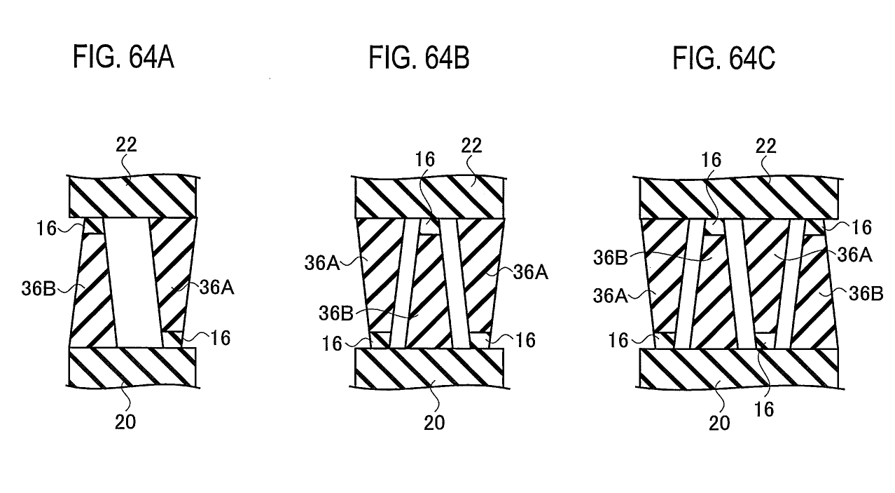

FIG. 64A is a sectional view showing a structural example of the sealed part according to a thirty-sixth practical example. As shown in FIG. 64A, in the present practical example, a sectional shape of the first base part 36B and the second base part 36A is a staggered wedge shape.

FIG. 64B is a sectional view showing a structural example of the sealed part according to a thirty-seventh practical example. As shown in FIG. 64B, in the present practical example, a sectional shape of the first base part 36B formed in two pieces and the second base part 36A inserted between the first base parts 36B via predetermined space is a staggered wedge shape.

FIG. 64C is a sectional view showing a structural example of the sealed part according to a thirty-eighth practical example. As shown in FIG. 64C, in the present practical example, a sectional shape of the first base part 36B and the second base part 36A each formed in two pieces via predetermined space one after the other is a staggered wedge shape.

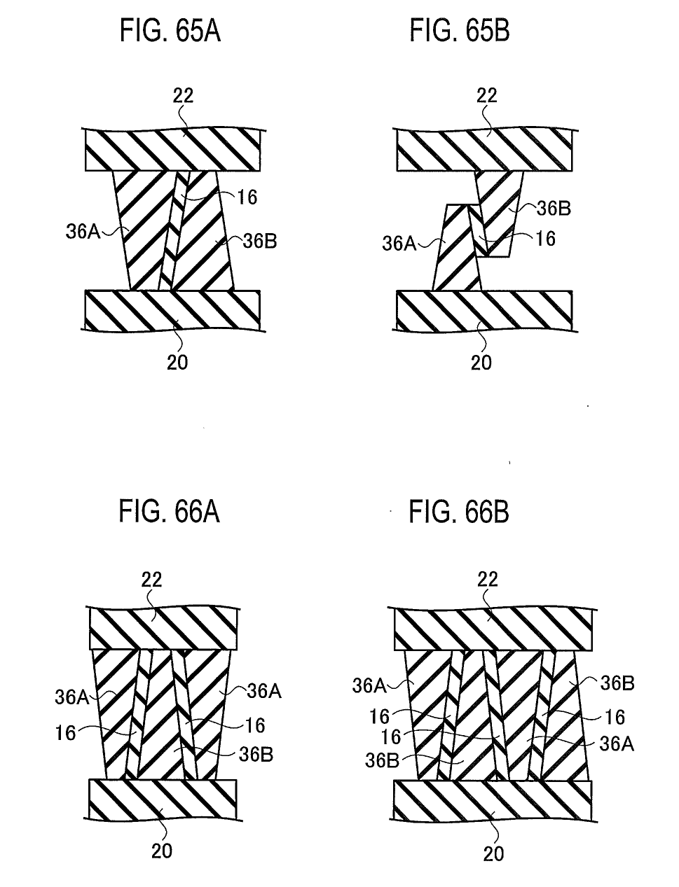

FIG. 65A is a sectional view showing a structural example of the sealed part according to a thirty-ninth practical example. As shown in FIG. 65A, in the present practical example, a sectional shape of the first base part 36B and the second base part 36A is a staggered wedge shape, and each surface thereof in vertical direction is mutually bonded via the bonding part 16.

FIG. 65B is a sectional view showing a structural example of the sealed part according to a forty practical example. As shown in FIG. 65B, in the present practical example, a sectional shape of the first base part 36B and the second base part 36A is a staggered wedge shape, and a part of each surface thereof in vertical direction is mutually bonded via the bonding part 16.

FIG. 66A is a sectional view showing a structural example of the sealed part according to a forty-first practical example. As shown in FIG. 66A, in the present practical example, a sectional shape of the first base part 36B formed in two pieces and the second base part 36A inserted to be contacted between the first base parts 36B via the bonding part 16 is a staggered wedge shape.

FIG. 66B is a sectional view showing a structural example of the sealed part according to a forty-second practical example. As shown in FIG. 66B, in the present practical example, a sectional shape of the first base part 36B and the second base part 36A each formed in two pieces is a staggered wedge shape, and each surface thereof is contacted with each other via the bonding part 16.

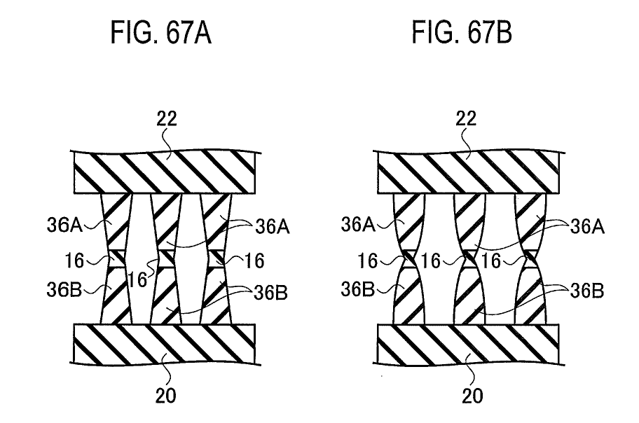

FIG. 67A is a sectional view showing a structural example of the sealed part according to a forty-third practical example. As shown in FIG. 67A, in this practical example, a sectional shape of the first base part 36B and the second base part 36A each formed in three pieces is a taper shape to which cross-sectional area becomes smaller as being away from the first substrate 20 and the second substrate 22.

FIG. 67B is a sectional view showing a structural example of the sealed part according to a forty-fourth practical example. As shown in FIG. 67B, in the present practical example, a sectional shape of the first base part 36B and the second base part 36A each formed in three pieces is a spindle-formed taper shape to which cross-sectional area becomes smaller as being away from the first substrate 20 and the second substrate 22.

As mentioned above, according to the present invention, there can be provided the DSCs which can reduce fabrication costs and improve the durability, and the fabrication method of such DSCs. Moreover, there can be provided the DSCs which can reduce the optical loss, and the fabrication method of such DSCs.

### Other Embodiments

The first to third embodiments has been described, as a disclosure including associated description and drawings to be construed as illustrative, not restrictive. This disclosure makes clear a variety of alternative embodiments, working examples, and operational techniques for those skilled in the art.

Such being the case, the present invention covers a variety of embodiments, whether described or not.

### INDUSTRIAL APPLICABILITY

Therefore, the dye-sensitized photovoltaic device of the present invention is applicable to various systems e.g., an auxiliary power supply for various electronic equipments, e.g., portable transmitter devices and game machine devices, and a driving power supply of wireless sensor modules, by applying as an electronic power supply.

What is claimed is:

1. A dye-sensitized photovoltaic device comprising:
a first substrate;
a first electrode disposed on the first substrate;
a porous semiconductor layer disposed on the first electrode and configured to include semiconductor fine particles and dye molecules;
an electrolysis solution configured to be contacted with the porous semiconductor layer, and to dissolve a redox electrolyte in a solvent;
a second electrode configured to be contacted with the electrolysis solution;
a second substrate disposed on the second electrode; and
a sealed part disposed between the first substrate and the second substrate, and configured to seal the electrolysis solution, wherein
the sealed part is configured to which a burning body of a paste containing a glass frit is fusion bonded.

2. The dye-sensitized photovoltaic device according to claim 1, wherein the glass frit is composed of a powdered Bi—B—Si based oxide.

3. The dye-sensitized photovoltaic device according to claim 1, wherein the sealed part comprises at least one of a first base part having a predetermined height formed with the burning body of the paste containing the glass frit, the first base part being positioned in the first substrate side, and a second base part having a predetermined height formed with the burning body of the paste containing the glass frit, the second base part being positioned in the second substrate side.

4. The dye-sensitized photovoltaic device according to claim 3, wherein the first base part and the second base part are respectively formed in equal to or greater than in two pieces.

5. The dye-sensitized photovoltaic device according to claim 3, wherein the first base part and the second base part are disposed so that a tip part of the first base part and a tip part of the second base part are opposed to each other.

6. The dye-sensitized photovoltaic device according to claim 1, wherein the first base part and the second base part are disposed so that a position of a tip part of the first base part and a position of a tip part of the second base part are in a staggered configuration.

7. The dye-sensitized photovoltaic device according to claim 3, wherein the first base part and the second base part have a taper shape to which a cross-sectional area becomes smaller as the first base part and the second base part are away from the first substrate and the second substrate.

8. The dye-sensitized photovoltaic device according to claim 7, wherein the first base part and the second base part have a wedge shape in cross section.

9. The dye-sensitized photovoltaic device according to claim 2, wherein the first base part or the second base part is fusion bonded to the first substrate or the second substrate by irradiating a contact part with the first substrate or the second substrate with infrared laser.

10. The dye-sensitized photovoltaic device according to claim 2, wherein the first base part or the second base part is fusion bonded to each other by irradiating a contact part between the first base part and the second base part with infrared laser.

11. The dye-sensitized photovoltaic device according to claim 1, wherein a plurality of cells composed of the dye-sensitized photovoltaic device are connected in series.

12. The dye-sensitized photovoltaic device according to claim 1, wherein an integrated structure of the dye-sensitized photovoltaic device is monolithic structure.

13. The dye-sensitized photovoltaic device according to claim 12 further comprising a separator having a predetermined height between the porous semiconductor layer and the second electrode.

14. The dye-sensitized photovoltaic device according to claim 13, wherein the porous semiconductor layer and the separator have the same kind of particulates from which the particle diameters mutually differ, and
the particle diameter of the particulates with which the porous semiconductor layer is provided is relatively smaller than the particle diameter of the particulates with which the separator is provided.

15. The dye-sensitized photovoltaic device according to claim 13, wherein the first electrode is a metal electrode having an aperture, and
the second electrode, the separator, the porous semiconductor layer, and the first electrode are disposed in order of the second electrode, the separator, the porous semiconductor layer, and the first electrode from the first substrate side.

16. The dye-sensitized photovoltaic device according to claim 13, wherein the metal electrode having the aperture is a mesh electrode having honeycomb structure.

17. A fabrication method of a dye-sensitized photovoltaic device, the fabrication method comprising:
forming a first electrode on a first substrate;
forming a porous semiconductor layer having semiconductor fine particles on the first electrode;
impregnating the porous semiconductor layer with a dye solution to adsorbing dye molecules;
forming the second electrode on the second substrate;
coating a paste containing a glass frit on the first substrate side and forming a first base part having a predetermined height;
coating the paste containing the glass frit on the second substrate side and forming a second base part having a predetermined height;
annealing the first base part and the second base part;
contacting the first base part with the second base part so that the first substrate and the second substrate are opposed to each other;
irradiating a contact part between the first base part and the second base part with infrared laser to be fusion bonded to each other; and
injecting an electrolysis solution in which a redox electrolyte is dissolved in a solvent between the first substrate and the second substrate.

18. A fabrication method of a dye-sensitized photovoltaic device, the fabrication method comprising:
forming a first electrode on a first substrate;
forming a porous semiconductor layer having semiconductor fine particles on the first electrode;
impregnating the porous semiconductor layer with a dye solution to adsorbing dye molecules;
forming the second electrode on the second substrate;
coating a paste containing glass frit on any one of the first substrate side and the second substrate side, and forming a first base part or a second base part having a predetermined height;
annealing the first base part or the second base part;
contacting the first base part with the second base part, or the second base part with the first substrate so that the first substrate and the second substrate are opposed to each other;
irradiating a contact part between the first base part and the second substrate, or a contact part between the second base part and the first substrate with infrared laser to be fusion bonded to each other; and
injecting an electrolysis solution in which a redox electrolyte is dissolved in a solvent between the first substrate and the second substrate.

19. A fabrication method of a dye-sensitized photovoltaic device, the fabrication method comprising:
forming a first substrate;
forming a second substrate;
forming a second electrode on the first substrate;
forming a separator having a predetermined height on the second electrode;
forming a porous semiconductor layer having semiconductor particulates on the separator;
impregnating the porous semiconductor layer with a dye solution to adsorbing dye molecules;
forming a first electrode being a metal electrode having an aperture on the porous semiconductor layer; and
sealing an electrolysis solution in which a redox electrolyte is dissolved in a solvent with a sealed part disposed between the first substrate and the second substrate.
